(19) United States
(12) Patent Application Publication
(10) Pub. No.: US 2023/0041585 A1
(43) Pub. Date: Feb. 9, 2023

(54) POWER CONTROL PARAMETER CONFIGURATION FOR CONFIGURED GRANTS

(71) Applicant: QUALCOMM Incorporated, San Diego, CA (US)

(72) Inventors: Mostafa Khoshnevisan, San Diego, CA (US); Yitao Chen, San Diego, CA (US); Jing Sun, San Diego, CA (US); Xiaoxia Zhang, San Diego, CA (US)

(21) Appl. No.: 17/393,166

(22) Filed: Aug. 3, 2021

(51) Int. Cl. H04W 52/14; H04W 72/12; H04W 72/14; H04L 5/00

(52) U.S. Cl. CPC H04W 52/143; H04W 72/1289; H04W 72/14; H04L 5/0051

(57) ABSTRACT

This disclosure provides methods, devices, and systems supporting power control parameter configuration for configured grants (CGs). In some implementations, a user equipment (UE) may receive control signaling configuring multiple sounding reference signal (SRS) resource sets and multiple sets of power control parameters for CG uplink transmission. The UE may receive downlink control information (DCI) scheduling a retransmission and indicating which set of power control parameters the UE is to use for the CG uplink retransmission. In some other implementations, the control signaling may configure multiple SRS resources sets but a single set of power control parameters. The UE may receive DCI activating the CG configuration or scheduling a retransmission, the DCI indicating a second set of power control parameters not configured by the control signaling. The UE may automatically use the power control parameters configured by the control signaling or may determine a second set based on the DCI.

### TECHNICAL FIELD

The following relates to wireless communications, including power control parameter configuration for configured grants (CGs).

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a base station may configure a UE with a configured grant (CG) for uplink transmission. The UE may receive first signaling indicating the configuration in advance for one or more CG uplink transmissions on a semi-periodic basis. As part of the CG configuration, the base station may configure the UE with a first set of parameters for CG uplink transmissions. In some examples, however, the base station may transmit second signaling activating the CG configuration or scheduling a retransmission for the CG configuration that may include a parameter or value that fails to align with the configured parameters for the CG configuration.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications. The method may include receiving control signaling configuring a first sounding reference signal (SRS) resource set, a second SRS resource set, and a configured grant (CG) configuration including a first set of power control parameters and a second set of power control parameters, for CG uplink transmission and transmitting an uplink message based on the CG configuration. The method may further include receiving downlink control information (DCI) scheduling a retransmission of the uplink message according to the CG configuration, the DCI indicating one or more of the first set of power control parameters or the second set of power control parameters, and retransmitting the uplink message based on the DCI and using the indicated one or more of the first set of power control parameters or the second set of power control parameters with one or both of the first SRS resource set or the second SRS resource set.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to receive control signaling configuring a first SRS resource set, a second SRS resource set, and a CG configuration including a first set of power control parameters and a second set of power control parameters, for CG uplink transmission and transmit an uplink message based on the CG configuration. The instructions may be further executable by the processor to cause the apparatus to receive DCI scheduling a retransmission of the uplink message according to the CG configuration, the DCI indicating one or more of the first set of power control parameters or the second set of power control parameters, and retransmit the uplink message based on the DCI and using the indicated one or more of the first set of power control parameters or the second set of power control parameters with one or both of the first SRS resource set or the second SRS resource set.

Another innovative aspect of the subject matter described in this disclosure can be implemented in an apparatus for wireless communications. The apparatus may include means for receiving control signaling configuring a first SRS resource set, a second SRS resource set, and a CG configuration including a first set of power control parameters and a second set of power control parameters, for CG uplink transmission and means for transmitting an uplink message based on the CG configuration. The apparatus may further include means for receiving DCI scheduling a retransmission of the uplink message according to the CG configuration, the DCI indicating one or more of the first set of power control parameters or the second set of power control parameters, and means for retransmitting the uplink message based on the DCI and using the indicated one or more of the first set of power control parameters or the second set of power control parameters with one or both of the first SRS resource set or the second SRS resource set.

Another innovative aspect of the subject matter described in this disclosure can be implemented in a non-transitory computer-readable medium storing code for wireless communications. The code may include instructions executable by a processor to receive control signaling configuring a first SRS resource set, a second SRS resource set, and a CG configuration including a first set of power control parameters and a second set of power control parameters, for CG uplink transmission and transmit an uplink message based on the CG configuration. The code may further include instructions executable by the processor to receive DCI scheduling a retransmission of the uplink message according to the CG configuration, the DCI indicating one or more of the first set of power control parameters or the second set of power control parameters, and retransmit the uplink message based on the DCI and using the indicated one or more of the first set of power control parameters or the second set of power control parameters with one or both of the first SRS resource set or the second SRS resource set.

In some implementations, the method, apparatuses, and non-transitory computer-readable medium may be configured to determine to use one or both of the first SRS resource set or the second SRS resource set based on the DCI, a first association between the first set of power control parameters and the first SRS resource set, and a second association between the second set of power control parameters and the second SRS resource set, where the retransmitting may be further based on the determining.

In some implementations of the method, apparatuses, and non-transitory computer-readable medium, the DCI includes a field for dynamic switching. In some implementations, the method, apparatuses, and non-transitory computer-readable medium may be configured to determine to use the first set of power control parameters with the first SRS resource set based on a first value of the field for dynamic switching, the second set of power control parameters with the second SRS resource set based on a second value of the field for dynamic switching, both the first set of power control parameters with the first SRS resource set and the second set of power control parameters with the second SRS resource set according to a first order based on a third value of the field for dynamic switching, or both the first set of power control parameters with the first SRS resource set and the second set of power control parameters with the second SRS resource set according to a second order based on a fourth value of the field for dynamic switching, where the retransmitting may be further based on the determining.

Another innovative aspect of the subject matter described in this disclosure can be implemented in a method for wireless communications. The method may include receiving radio resource control (RRC) signaling configuring a first SRS resource set, a second SRS resource set, and a CG configuration including a first set of power control parameters for CG uplink transmission, receiving DCI associated with the CG configuration, the DCI indicating at least a second set of power control parameters different than the first set of power control parameters, and transmitting an uplink message based on the DCI and using the first set of power control parameters associated with the first SRS resource set based on the RRC signaling configuring the first set of power control parameters.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to receive RRC signaling configuring a first SRS resource set, a second SRS resource set, and a CG configuration including a first set of power control parameters for CG uplink transmission, receive DCI associated with the CG configuration, the DCI indicating at least a second set of power control parameters different than the first set of power control parameters, and transmit an uplink message based on the DCI and using the first set of power control parameters associated with the first SRS resource set based on the RRC signaling configuring the first set of power control parameters.

Another innovative aspect of the subject matter described in this disclosure can be implemented in an apparatus for wireless communications. The apparatus may include means for receiving RRC signaling configuring a first SRS resource set, a second SRS resource set, and a CG configuration including a first set of power control parameters for CG uplink transmission, means for receiving DCI associated with the CG configuration, the DCI indicating at least a second set of power control parameters different than the first set of power control parameters, and means for transmitting an uplink message based on the DCI and using the first set of power control parameters associated with the first SRS resource set based on the RRC signaling configuring the first set of power control parameters.

Another innovative aspect of the subject matter described in this disclosure can be implemented in a non-transitory computer-readable medium storing code for wireless communications. The code may include instructions executable by a processor to receive RRC signaling configuring a first SRS resource set, a second SRS resource set, and a CG configuration including a first set of power control parameters for CG uplink transmission, receive DCI associated with the CG configuration, the DCI indicating at least a second set of power control parameters different than the first set of power control parameters, and transmit an uplink message based on the DCI and using the first set of power control parameters associated with the first SRS resource set based on the RRC signaling configuring the first set of power control parameters.

In some implementations, the method, apparatuses, and non-transitory computer-readable medium may be configured to transmit, in response to the DCI, a signal including an error indication based on the DCI indicating at least the second set of power control parameters and the RRC signaling configuring the first set of power control parameters.

In some implementations of the method, apparatuses, and non-transitory computer-readable medium, the DCI includes a field for dynamic switching indicating at least the second set of power control parameters. In some implementations, the method, apparatuses, and non-transitory computer-readable medium may be configured to refrain from using the field for dynamic switching based on the RRC signaling failing to configure the second set of power control parameters, where transmitting the uplink message using the first set of power control parameters may be based on the refraining.

Another innovative aspect of the subject matter described in this disclosure can be implemented in a method for wireless communications. The method may include receiving RRC signaling configuring a first SRS resource set, a second SRS resource set, and a CG configuration including a first set of power control parameters for CG uplink transmission, receiving DCI associated with the CG configuration, the DCI indicating at least a second set of power control parameters different than the first set of power control parameters, and transmitting an uplink message based on the DCI and the CG configuration, the uplink message being transmitted using at least the second set of power control parameters based on the DCI indicating at least the second set of power control parameters.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to receive RRC signaling configuring a first SRS resource set, a second SRS resource set, and a CG configuration including a first set of power control parameters for CG uplink transmission, receive DCI associated with the CG configuration, the DCI indicating at least a second set of power control parameters different than the first set of power control parameters, and transmit an uplink message based on the DCI and the CG configuration, the uplink message being transmitted using at least the second set of power control parameters based on the DCI indicating at least the second set of power control parameters.

Another innovative aspect of the subject matter described in this disclosure can be implemented in an apparatus for wireless communications. The apparatus may include means for receiving RRC signaling configuring a first SRS resource set, a second SRS resource set, and a CG configuration including a first set of power control parameters for CG uplink transmission, means for receiving DCI associated with the CG configuration, the DCI indicating at least a second set of power control parameters different than the first set of power control parameters, and means for transmitting an uplink message based on the DCI and the CG configuration, the uplink message being transmitted using at least the second set of power control parameters based on the DCI indicating at least the second set of power control parameters.

Another innovative aspect of the subject matter described in this disclosure can be implemented in a non-transitory computer-readable medium storing code for wireless communications. The code may include instructions executable by a processor to receive RRC signaling configuring a first SRS resource set, a second SRS resource set, and a CG configuration including a first set of power control parameters for CG uplink transmission, receive DCI associated with the CG configuration, the DCI indicating at least a second set of power control parameters different than the first set of power control parameters, and transmit an uplink message based on the DCI and the CG configuration, the uplink message being transmitted using at least the second set of power control parameters based on the DCI indicating at least the second set of power control parameters.

In some implementations of the method, apparatuses, and non-transitory computer-readable medium, the DCI includes a first SRS resource indicator (SRI) and a second SRI. In some implementations, the method, apparatuses, and non-transitory computer-readable medium may be configured to determine the second set of power control parameters based on the second SRI.

In some implementations of the method, apparatuses, and non-transitory computer-readable medium, the RRC signaling includes a set of multiple SRI power control identifiers associated with the second SRS resource set. In some implementations, the method, apparatuses, and non-transitory computer-readable medium may be configured to determine the second set of power control parameters based on an SRI power control identifier of the set of multiple SRI power control identifiers associated with the second SRS resource set and on a selection criterion.

Another innovative aspect of the subject matter described in this disclosure can be implemented in a method for wireless communications. The method may include transmitting, to a user equipment (UE), control signaling configuring a first SRS resource set, a second SRS resource set, and a CG configuration including a first set of power control parameters and a second set of power control parameters, for CG uplink transmission. The method may further include transmitting, to the UE, DCI scheduling a retransmission of the uplink message according to the CG configuration based on a failure to receive an uplink message from the UE, the DCI indicating one or more of the first set of power control parameters or the second set of power control parameters, and receiving, from the UE, the retransmission of the uplink message using one or both of the first SRS resource set or the second SRS resource set based on the indicated one or more of the first set of power control parameters or the second set of power control parameters.

Another innovative aspect of the subject matter described in this disclosure can be implemented in an apparatus for wireless communications. The apparatus may include a processor, memory coupled with the processor, and instructions stored in the memory. The instructions may be executable by the processor to cause the apparatus to transmit, to a UE, control signaling configuring a first SRS resource set, a second SRS resource set, and a CG configuration including a first set of power control parameters and a second set of power control parameters, for CG uplink transmission. The instructions may be further executable by the processor to cause the apparatus to transmit, to the UE, DCI scheduling a retransmission of the uplink message according to the CG configuration based on a failure to receive an uplink message from the UE, the DCI indicating one or more of the first set of power control parameters or the second set of power control parameters, and receive, from the UE, the retransmission of the uplink message using one or both of the first SRS resource set or the second SRS resource set based on the indicated one or more of the first set of power control parameters or the second set of power control parameters.

Another innovative aspect of the subject matter described in this disclosure can be implemented in an apparatus for wireless communications. The apparatus may include means for transmitting, to a UE, control signaling configuring a first SRS resource set, a second SRS resource set, and a CG configuration including a first set of power control parameters and a second set of power control parameters, for CG uplink transmission. The apparatus may further include means for transmitting, to the UE, DCI scheduling a retransmission of the uplink message according to the CG configuration based on a failure to receive an uplink message from the UE, the DCI indicating one or more of the first set of power control parameters or the second set of power control parameters, and means for receiving, from the UE, the retransmission of the uplink message using one or both of the first SRS resource set or the second SRS resource set based on the indicated one or more of the first set of power control parameters or the second set of power control parameters.

Another innovative aspect of the subject matter described in this disclosure can be implemented in a non-transitory computer-readable medium storing code for wireless communications. The code may include instructions executable by a processor to transmit, to a UE, control signaling configuring a first SRS resource set, a second SRS resource set, and a CG configuration including a first set of power control parameters and a second set of power control parameters, for CG uplink transmission. The code may include further instructions executable by the processor to transmit, to the UE, DCI scheduling a retransmission of the uplink message according to the CG configuration based on a failure to receive an uplink message from the UE, the DCI indicating one or more of the first set of power control parameters or the second set of power control parameters, and receive, from the UE, the retransmission of the uplink message using one or both of the first SRS resource set or the second SRS resource set based on the indicated one or more of the first set of power control parameters or the second set of power control parameters.

### BRIEF DESCRIPTION OF THE DRAWINGS

Details of one or more implementations of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIGS. 1-4 illustrate examples of wireless communications systems that support power control parameter configuration for configured grants (CGs) in accordance with aspects of the present disclosure.

FIGS. 5 and 6 illustrate examples of process flows that supports power control parameter configuration for CGs in accordance with aspects of the present disclosure.

FIGS. 7 and 8 show block diagrams of devices that support power control parameter configuration for CGs in accordance with aspects of the present disclosure.

FIG. 9 shows a block diagram of a communications manager that supports power control parameter configuration for CGs in accordance with aspects of the present disclosure.

FIG. 10 shows a diagram of a system including a device that supports power control parameter configuration for CGs in accordance with aspects of the present disclosure.

FIGS. 11 and 12 show block diagrams of devices that support power control parameter configuration for CGs in accordance with aspects of the present disclosure.

FIG. 13 shows a block diagram of a communications manager that supports power control parameter configuration for CGs in accordance with aspects of the present disclosure.

FIG. 14 shows a diagram of a system including a device that supports power control parameter configuration for CGs in accordance with aspects of the present disclosure.

FIGS. 15-18 show flowcharts illustrating methods that support power control parameter configuration for CGs in accordance with aspects of the present disclosure.

Like reference numbers and designations in the various drawings indicate like elements.

### DETAILED DESCRIPTION

Configured grant (CG) uplink communications are communications in which a user equipment (UE) may receive a configuration in advance that applies to multiple uplink transmissions, the uplink transmissions scheduled on a semi-periodic basis. For example, a base station may configure the UE with either a Type 1 CG configuration (such as a radio resource control (RRC) activated grant configuration) or a Type 2 CG configuration (such as a downlink control information (DCI) activated grant configuration). In some examples, the base station may configure, via RRC signaling, the UE with multiple sounding reference signal (SRS) resource sets that correspond to different beams and different transmission/reception points (TRPs) at the base station. The UE may use one or more of the configured SRS resource sets for transmitting SRSs that provide information related to transmitting the semi-periodic uplink messages according to the CG configuration. However, in some examples, a DCI message activating a CG configuration or scheduling a retransmission for a CG configuration may indicate a parameter (for example, in a DCI field for dynamic switching) that does not align with parameters configured for the CG configuration. As an example, an initial CG configuration may include multiple sets of power control parameters, and the UE may use different sets of power control parameters for transmitting uplink messages to different TRPs in order to support multi-TRP (mTRP) communications. However, in some implementations, the UE may receive a DCI message scheduling a retransmission that indicates to use the initial CG configuration but includes a DCI field for dynamic switching that indicates single-TRP (sTRP) retransmission. As another example, an initial CG configuration may include a single set of power control parameters supporting sTRP communications, but the UE may receive a DCI message indicating the initial CG configuration and including a DCI field for dynamic switching that indicates mTRP activation or retransmission (or the DCI field for dynamic switching at least may indicate using a second set of power control parameters not configured in the initial CG configuration).

Various aspects generally relate to power control parameter configuration for CG uplink transmissions, and specifically, techniques supporting dynamic switching between sTRP and mTRP configurations. Some aspects more particularly relate to techniques enabling a UE to determine which power control parameters to associate with which SRS resource sets for CG uplink retransmissions. In some examples, a base station may configure a UE—via RRC signaling, DCI signaling, or both—with at least first and second SRS resource sets and first and second sets of power control parameters that may be used for an initial mTRP CG uplink transmission. However, in some such examples, the UE may receive DCI indicating an sTRP configuration (for example, via a DCI field for dynamic switching) and scheduling a retransmission of the CG uplink transmission. The UE may retransmit the CG uplink transmission using the sTRP configuration according to the DCI field for dynamic switching and based on implicitly associating the first set of power control parameters with the first SRS resource set and associating the second set of power control parameters with the second SRS resource set.

Additionally or alternatively, the UE may be configured—via RRC signaling—with a CG configuration that includes one set of power control parameters for sTRP CG uplink transmissions, but the UE may receive DCI indicating at least a second SRS resource set (such as for sTRP or mTRP CG uplink transmissions) that activates the CG configuration or schedules a retransmission for a CG uplink transmission according to the CG configuration. In some such examples, the UE may determine an error case in response to the DCI field for dynamic switching including a value (for example, associated with the second SRS resource set) corresponding to parameters (for example, a second set of power control parameters) not configured in the CG configuration, and the UE may transmit a signal that includes an error indication to the base station. Additionally or alternatively, the UE may ignore the DCI field for dynamic switching and may transmit a CG uplink transmission in accordance with the first set of power control parameters and the first SRS resource set configured for the CG configuration in the RRC signaling. In some other such examples, the UE may determine a second set of power control parameters (for example, not configured for the CG configuration in the RRC signaling) based on the DCI field for dynamic switching indicating the second SRS resource set. In such examples, the UE may transmit the CG uplink transmission in accordance with the second set of power control parameters and the second SRS resource set indicated by the DCI field for dynamic switching. In some such examples, the UE may determine the second set of power control parameters based on a second SRS resource indicator (SRI), if present in the DCI, or based on a power control configuration (for example, configured via an sri-PUSCH-PowerControl field) with a lowest identifier (ID) associated with the second SRS resource set indicated in the RRC signaling.

Particular aspects of the subject matter described in this disclosure may be implemented to realize one or more of the following potential advantages. The techniques employed by the described communication devices may provide benefits and enhancements to the operation of wireless communication devices, including enhanced power control for CG uplink transmissions and retransmissions. For example, the UE and base station may coordinate power control parameters based on associations between configured SRS resource sets and configured sets of power control parameters. Coordinating power control parameter selection may improve communication reliability by supporting power control parameters that are known at both the base station and UE and that are selected for reliable transmission by correlating the power control parameters with specific corresponding SRS resource sets. Furthermore, the UE and base station may support improved TRP-based flexibility for CG uplink transmissions. In some examples, the base station may indicate a dynamic switch between sTRP and mTRP operation or between mTRP and sTRP operation based on channel conditions, interference, obstructions, UE mobility, or any combination thereof. Dynamically switching from sTRP to mTRP CG uplink transmission may improve spatial diversity and communication reliability (for example, if a first communication beam directed towards a first TRP is blocked or experiencing significant interference). Improving communication reliability may correspondingly improve the wireless communications system efficiency (for example, reducing channel overhead and signaling latency) by potentially reducing the number of retransmissions used by the UE to successfully communicate information to the network. Alternatively, dynamically switching from mTRP to sTRP CG uplink transmission may improve power savings at the UE and the network by reducing spatial multiplexing and corresponding processes.

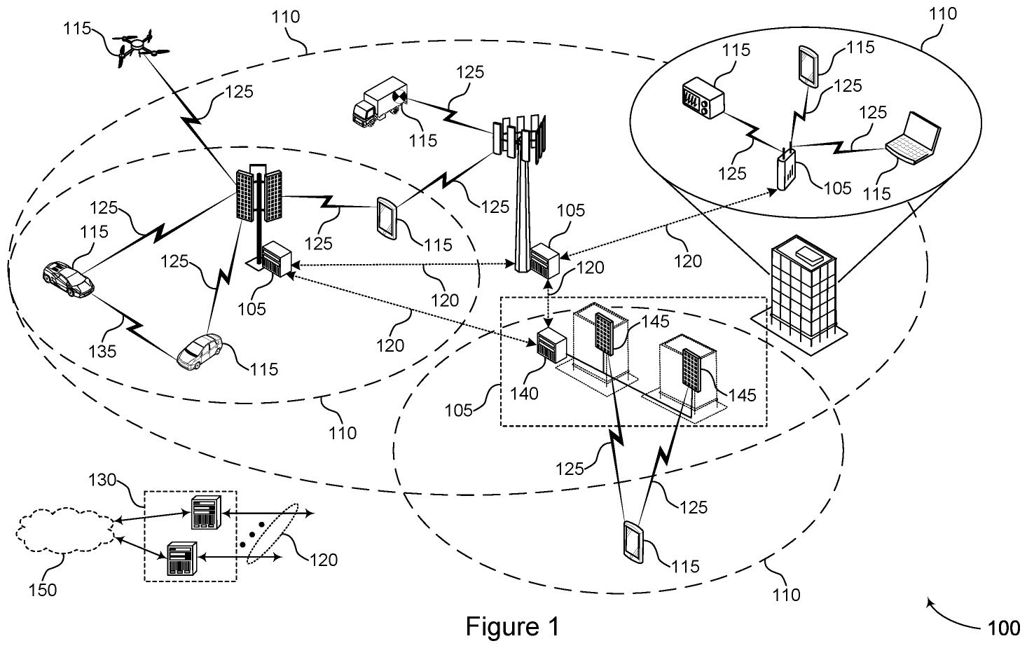

FIG. 1 illustrates an example of a wireless communications system 100 that supports power control parameter configuration for CGs in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 may be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links.

One or more of the base stations 105 may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, in which the symbol period and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other examples, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, when receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority management and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which the device may provide HARQ feedback in a specific slot for data received in a previous symbol in the slot. In other examples, the device may provide HARQ feedback in a subsequent slot, or according to some other time interval.

In some aspects, a base station 105 may configure a UE 115 with a dynamic grant (DG) for an uplink transmission. The DG may include a set of power control parameters (such as a set of P0 values, a set of alpha values, a set of path loss reference signals (PL-RSs), a set of closed loop indexes, or any combination thereof), each of which may have an associated ID. For example, each member in the set of P0 and alpha values used for open loop power control may have an associated ID and each member in a list of PL-RSs may have an associated ID. In some examples, the base station 105 may transmit an uplink DCI scheduling a PUSCH that may include an ID associated with a set of power control parameters. For example, if the value of the ID included in the uplink DCI is of value X, the UE 115 may use the set of power control parameters that is associated with an ID with a value of X. As such, the UE 115 may use the set of power control parameters indicated in the uplink DCI for the corresponding PUSCH transmission.

Additionally or alternatively, the base station 105 may transmit control signaling to a UE 115 that may configure the UE 115 with a CG configuration. For example, the control signaling may configure the UE 115 with a Type 1 CG (such that the CG may be activated via RRC signaling) or a Type 2 CG (such that the CG may be activated via a DCI activation message). In some aspects, the base station 105 may also configure the UE 115 with multiple SRS resource sets in which each SRS resource set corresponds to a beam (for example, a communication beam, such as an uplink transmit beam for uplink transmission) and a TRP at the base station 105. During the CG configuration, the base station 105 may also configure the UE 115 with multiple sets of power control parameters that the UE 115 may associate with the multiple SRS resource sets for CG uplink transmissions. For example, the base station 105 may configure the UE 115 with two SRS resource sets and two sets of power control parameters, and the UE 115 may associate a first SRS resource set with a first set of power control parameters and a second SRS resource set with a second set of power control parameters. An order of the first and second SRS resource sets and an order of the first and second sets of power control parameters may be based on the order of fields in the control signaling. The UE 115 may transmit a first CG uplink transmission using the first SRS resource set and the associated first set of power control parameters to a first TRP and may transmit a second CG uplink transmission using the second SRS resource set and the associated second set of power control parameters to a second TRP, achieving an mTRP CG uplink transmission to the base station 105. The first TRP and the second TRP may be located on the same base station 105 or different base stations 105.

In some aspects, the base station 105 may transmit a DCI message to trigger CG activation that may indicate to the UE 115 which of the sets of power control parameters to use for the activated CG uplink transmission. For example, the DCI message may include a field for dynamic switching which may indicate to the UE 115 to use the first set of power control parameters and participate in an sTRP CG uplink transmission, to use the second set of power control parameters and participate in an sTRP CG uplink transmission, or to use a combination thereof and participate in an mTRP CG uplink transmission. In some implementations, the field for dynamic switching may indicate a CG uplink transmission using SRS resources or power control parameters that do not align with the initial CG configuration. In some examples, the base station 105 may configure the UE 115 with two sets of power control parameters, but the field for dynamic switching indicates one SRS resource set for the CG uplink transmission or retransmission. In some other examples, the base station 105 may configure the UE 115 with one set of power control parameters, but the field for dynamic switching indicates two sets SRS resource sets (or at least a second SRS resource set) for the CG uplink transmission or retransmission.

In some examples, if the UE 115 is configured with the two SRS resource sets and the two sets of power control parameters, but the field for dynamic switching indicates to use one SRS resource set (for example, indicating sTRP), the UE 115 may transmit the CG uplink transmission according to the one set of power control parameters corresponding to the SRS resource set indicated by the field for dynamic switching. The association may be an implicit association known by both the UE 115 and the base station 105, such that the UE 115 may automatically identify that the first configured SRS resource set is associated with the first configured set of power control parameters and the second configured SRS resource set is associated with the second configured set of power control parameters. In some examples, the base station 105 may configure the UE 115 with two SRS resource sets and one set of power control parameters, but the field for dynamic switching may indicate the use of two sets of power control parameters (for example, indicating mTRP). In some examples, the UE 115 may transmit an error message (such as a negative acknowledgment (NACK) message or another error message) to the base station 105 in response to receiving the field for dynamic switching indicating the use of a second set of power control parameters. Additionally or alternatively, the UE 115 may ignore the field for dynamic switching and may associate the first set of configured power control parameters with the first SRS resource set and transmit the CG uplink transmission in accordance with the first set of power control parameters and the first SRS resource set (for example, regardless of the value of the DCI field for dynamic switching). In some other examples, the UE 115 may determine the second set of power control parameters for the SRS resource set indicated in the field for dynamic switching and may transmit the CG uplink transmission in accordance with the determined second set of power control parameters.

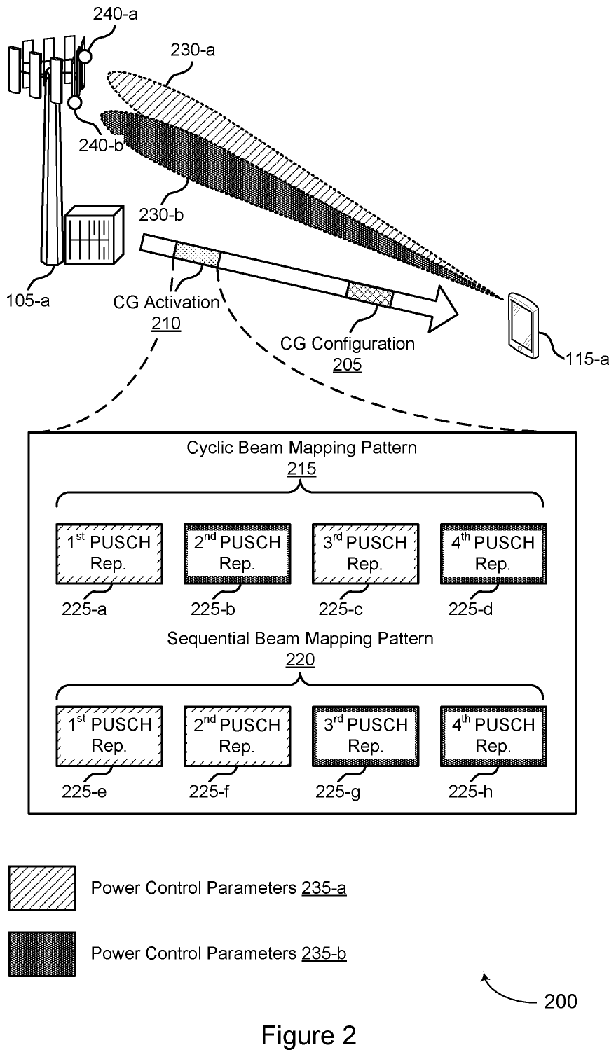

FIG. 2 illustrates an example of a wireless communications system 200 that supports power control parameter configuration for CGs in accordance with aspects of the present disclosure. The wireless communications system 200 may implement or be implemented to realize aspects of the wireless communications system 100. For example, the wireless communications system 200 may support communications between a UE 115-a and a base station 105-a, which may be examples of the corresponding devices described with reference to FIG. 1. The base station 105-a may configure the UE 115-a with a CG configuration 205 for CG uplink transmissions 225. In some examples, the UE 115-a may transmit a CG uplink transmission using multiple beams 230 to multiple respective TRPs 240 at the base station 105-a. In some examples, the base station 105-a may transmit a scheduling DCI message which may include a field for dynamic switching with a value that does not align with the configured parameters for the CG configuration 205. As such, the UE 115-a may use techniques described herein to transmit the scheduled CG uplink transmission 225 (for example, a CG uplink retransmission) using the indicated beam(s) 230 and corresponding power control parameters 235.

In the wireless communications system 200, the base station 105-a may configure the UE 115-a with a CG configuration 205 for CG uplink transmissions 225. For example, the base station 105-a may transmit control signaling configuring the CG configuration 205, which may correspond to either a Type 1 CG or a Type 2 CG. For example, if the CG configuration 205 is of Type 1, the base station 105-a may transmit a CG activation 210 in RRC signaling to activate the CG configuration for the CG uplink transmissions 225. For Type 1 CGs, the base station 105-a may also deactivate the CG configuration via RRC signaling. If the CG configuration 205 is of Type 2, the base station 105-a may transmit a CG activation 210 in DCI signaling to activate the CG configuration for the CG uplink transmissions 225. The activation DCI may include various fields that the UE 115-a may use to validate the activation DCI. For example, the activation DCI may include cyclic redundancy check (CRC) bits which may be scrambled via a configured scheduling radio network temporary identifier (CS-RNTI) corresponding to the UE 115-a, a new data indicator (NDI) with a value of zero (for example, NDI=0 indicating an initial transmission), and a redundancy version (RV) with a value of zero (for example, RV=0). For Type 2 CGs, the base station 105-a may similarly deactivate the CG configuration by transmitting a deactivation DCI to the UE 115-a.

In some examples, the base station 105-a may configure various transmission parameters (such as power control parameters 235) corresponding to the CG uplink transmissions 225 via the CG activation 210 message. In some examples, the configured transmission power control parameters 235 may include a value corresponding to the target power spectral density (for example, a P0 value), a value that indicates whether to enable or disable fractional power control for the CG uplink transmissions 225 (for example, an alpha value), a closed loop index, or some combination of these or other power control parameters. For both Type 1 and Type 2 CGs, the base station 105-a may configure the power control parameters 235 corresponding to the CG uplink transmissions 225 in the CG configuration 205 via RRC signaling (such as a ConfiguredGrantConfig message). For example, the ConfiguredGrantConfig message may include a p0-PUSCH-Alpha field which may configure the P0 value and the alpha value and may also include a powerControlLoopToUse field which may configure the closed loop index value for the CG uplink transmissions 225.

In some examples, the UE 115-a may also receive, from the base station 105-a, a list of path loss reference signals (PL-RS) which the base station 105-a may transmit via RRC signaling or DCI signaling depending on the CG Type configured in the CG configuration 205 message. For example, if the UE 115-a is configured with a Type 1 CG, the base station 105-a may transmit the PL-RS indices for an initial CG uplink transmission via RRC signaling (for example, the base station 105-a may transmit an rrc-ConfiguredUplinkGrant message which may include a pathlossReferenceIndex field). If the UE 115-a is configured with a Type 2 CG, the base station 105-a may include the PL-RS indexes as part of an SRI field that is included in the activation DCI with the CG activation 210. In some examples, the base station 105-a may request retransmission of a CG uplink transmission 225 from the UE 115-a via a scheduling DCI message which may include an SRI field that indicates the PL-RS indices for both Type 1 CG and Type 2 CG. The scheduling DCI message may include a CRC scrambled via a CS-RNTI and may include an NDI of value 1 (for example, indicating a retransmission).

In some examples, it may be advantageous for the base station 105-a to receive the CG uplink transmissions 225 from the UE 115-a at multiple TRPs 240 or multiple panels to improve robustness and reliability of the uplink transmissions. For example, if a first beam 230-a directed towards a first TRP 240-a at the base station 105-a is blocked via a physical object (such as a tree, a moving car, a building, among other examples) or the first TRP 240-a is experiencing interference (such as interference from signaling from other UEs 115 or self-interference), the base station 105-a may decode an uplink transmission from a second beam 230-b at a second TRP 240-b, increasing uplink reception reliability at the base station 105-a through spatial diversity. In some examples, the TRP 240-b may be located at a different base station 105 than the TRP 240-a, and the UE 115-a may transmit the CG uplink transmissions 225 to multiple base stations 105.

In some examples, the UE 115-a may transmit a CG uplink transmission 225—for example, an uplink transport block (TB)—with one or more repetitions (such as Type A repetitions or Type B repetitions). For a Type A repetition, the UE 115-a may transmit CG uplink transmission 225 repetitions that correspond to the same TB in different slots. For a Type B repetition, the UE 115-a may transmit CG uplink transmission 225 repetitions that correspond to the same TB in different mini-slots which may be smaller in size (for example, smaller in symbol size) than the slots. The base station 105-a may configure the number of repetitions for the CG uplink transmissions 225 in the CG activation 210 message via RRC signaling or dynamically through a time domain resource assignment (TDRA) field included in a DCI message (such as the activation DCI for an initial transmission or the scheduling DCI for a retransmission). In some examples, the UE 115-a may transmit all repetitions of a CG uplink transmission 225 using a single beam 230. For example, the UE 115-a may transmit all repetitions of the uplink message using a beam 230-a and the same set of power control parameters, and the base station 105-a may receive the repetitions at a single TRP 240-a.

In some implementations, however, the base station 105-a may receive different uplink repetitions at different TRPs 240, different panels, or different antennas for improved spatial diversity. Correspondingly, the UE 115-a may use multiple beams 230 (such as the beam 230-a and the beam 230-b) and multiple corresponding sets of power control parameters 235 (such as power control parameters 235-a and power control parameters 235-b) to transmit to the multiple TRPs 240 (such as the TRP 240-a and the TRP 240-b). In some examples, a DCI message (for example, including a CG activation 210 or scheduling a retransmission) may indicate the SRS resources in the SRS resource sets to the UE 115-a.

In some implementations, the base station 105-a may indicate for the UE 115-a to use sTRP uplink transmissions or mTRP uplink transmissions (for example, indicating to the UE 115-a via the CG activation 210 message to use one of the SRS resource sets for sTRP or both of the SRS resource sets for mTRP). To achieve dynamic switching between sTRP and mTRP, the base station 105-a may transmit a DCI message to the UE 115-a which may include a bit field for dynamic switching that indicates which power control parameters 235 and corresponding SRS resource set to use for the CG uplink transmissions 225. For example, the bit field for dynamic switching may have a size of two bits and indicate one of four configurations for the CG uplink transmissions 225. Alternatively, other size bit fields may be supported to indicate one of any quantity of configurations. A first value of the bit field for dynamic switching (for example, a value of ‘00’) may indicate to the UE 115-a to use the first SRS resource set corresponding to the first beam 230-a and the associated first set of power control parameters 235-a for an sTRP CG uplink transmission 225 to the TRP 240-a (for example, for any number of repetitions). A second value of the bit field for dynamic switching (for example, ‘01’) may indicate to the UE 115-a to use the second SRS resource set corresponding to the second beam 230-b and the associated second set of power control parameters 235-b for an sTRP CG uplink transmissions 225 to the TRP 240-b. A third value of the bit field for dynamic switching (for example, ‘10’) may indicate to the UE 115-a to use mTRP repetitions by first using the first SRS resource set and the first set of power control parameters 235-a for a CG uplink transmission 225 repetition to the TRP 240-a and second using the second SRS resource set and the second set of power control parameters 235-b for a CG uplink transmissions 225 repetition to the TRP 240-b. A fourth value of the bit field for dynamic switching (for example, ‘11’) may indicate to the UE 115-a to use mTRP repetitions by first using the second SRS resource set and the second set of power control parameters 235-b for a first CG uplink transmission 225 repetition to the TRP 240-b and second using the first SRS resource set and the first set of power control parameters 235-a for a second CG uplink transmission 225 repetition to the TRP 240-a.

To support the UE 115-a transmitting CG uplink transmission 225 repetitions with two beams 230 and two sets of power control parameters 235, the base station 105-a may introduce the second set of power control parameters 235-b using RRC signaling for Type 1 CG or Type 2 CG. For example, the base station 105-a may introduce a second p0-PUSCH-Alpha field and a second powerControlLoopToUse field in the ConfiguredGrantConfig message via RRC signaling. For Type 1 CG for mTRP CG uplink transmissions 225, the base station 105-a may include a second pathlossReferenceIndex field, a second srs-ResourceIndicator field, a second precodingAndNumberOfLayers field, or a combination of these or additional fields in RRC signaling, for example, via the rrc-ConfiguredUplinkGrant message. For Type 2 CG for mTRP CG uplink transmissions 225, the base station 105-a may indicate a first SRI and a second SRI with corresponding transmit precoding matrix indexes (TPMIs) via the activating DCI. The first SRI may indicate the first set of power control parameters 235-a and the second SRI may indicate the second set of power control parameters 235-b.

As illustrated in FIG. 2, in some examples, the CG activation 210 message may indicate an uplink repetition of four and the bit field for dynamic switching may indicate mTRP transmission starting with a repetition using the first SRS resource set (for example, indicated by a value of ‘10’). As such, the UE 115-a may transmit four repetitions of a CG uplink transmission 225 and alternate between transmitting a CG uplink transmission 225 repetition to the TRP 240-a corresponding to the first SRS resource set and using the first set of power control parameters 235-a and transmitting a CG uplink transmission 225 repetition to the TRP 240-b corresponding to the second SRS resource set and using the second set of power control parameters 235-b. In some examples, the base station 105-a may also indicate whether the CG uplink transmission pattern is a cyclic beam mapping pattern 215 or a sequential beam mapping pattern 220 (for example, via RRC signaling, CG activation 210 message, or both). In the example of the cyclic beam mapping pattern 215, the UE 115-a may alternate between the first SRS resource set and the second SRS resource set for each CG uplink transmission 225 repetition occasion. For example, the UE 115-a may transmit the CG uplink transmission 225-a and the CG uplink transmission 225-c to the TRP 240-a using the first SRS resource set and may transmit the CG uplink transmission 225-b and the CG uplink transmission 225-d to the TRP 240-b using the second SRS resource set. In the example of the sequential beam mapping pattern 220, the UE 115-a may sequentially transmit a first subset of the CG uplink transmission 225 repetitions using the first SRS resource set and then alternate to transmit a second subset of the CG uplink transmission 225 repetitions using the second SRS resource set. For example, the UE 115-a may transmit the CG uplink transmission 225-e and the CG uplink transmission 225-f to the TRP 240-a using the first SRS resource set and may transmit the CG uplink transmission 225-g and the CG uplink transmission 225-h to the TRP 240-b using the second SRS resource set.

In some examples of the wireless communications system 200, the base station 105-a may activate a CG configuration or request retransmission of a CG uplink transmission 225. However, in some implementations, a DCI message such as the activation DCI or scheduling DCI for retransmission for a CG configuration may include the field for dynamic switching with a value that does not align with the configured parameters indicated in the CG configuration 205, a CG activation 210, or both. In some examples, the CG configuration 205 may include two sets of power control parameters 235 for mTRP CG uplink messaging, but the DCI field for dynamic switching may indicate one set of power control parameters for sTRP. In some other examples, the CG configuration 205 may include one set of power control parameters 235, but the DCI field for dynamic switching may indicate the use of two sets of power control parameters 235 for mTRP CG uplink messaging (or at least indicate using a second set of power control parameters 235 not configured by the CG configuration 205).

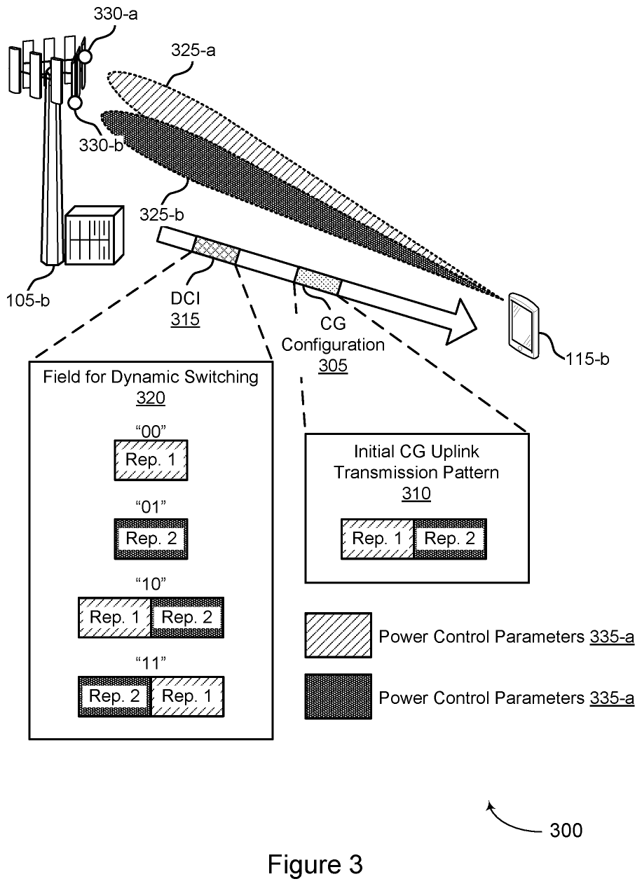

To ensure that the base station 105-a and the UE 115-a are coordinated as to which parameters the UE 115-a will use for the CG uplink transmission 225, the UE 115-a may operate in accordance with the techniques described herein. If the UE 115-a is configured with the first and second SRS resource sets and first and second sets of power control parameters 235 for the initial CG uplink transmission, but the UE 115-a receives a DCI field for dynamic switching indicating sTRP (for example, if the field for dynamic switching includes a bit value of ‘00’ or ‘01’), the UE 115-a may retransmit the CG uplink transmission 225 according to the field for dynamic switching and based on associating the first power control parameters 235-a with the first SRS resource set and associating the second power control parameters 235-b with the second SRS resource set. Examples in which the initial CG uplink transmission indicates multiple sets of power control parameters 235 for mTRP and the CG uplink retransmission request indicates one set of power control parameters 235 for sTRP are described in more detail herein, including with reference to FIG. 3.

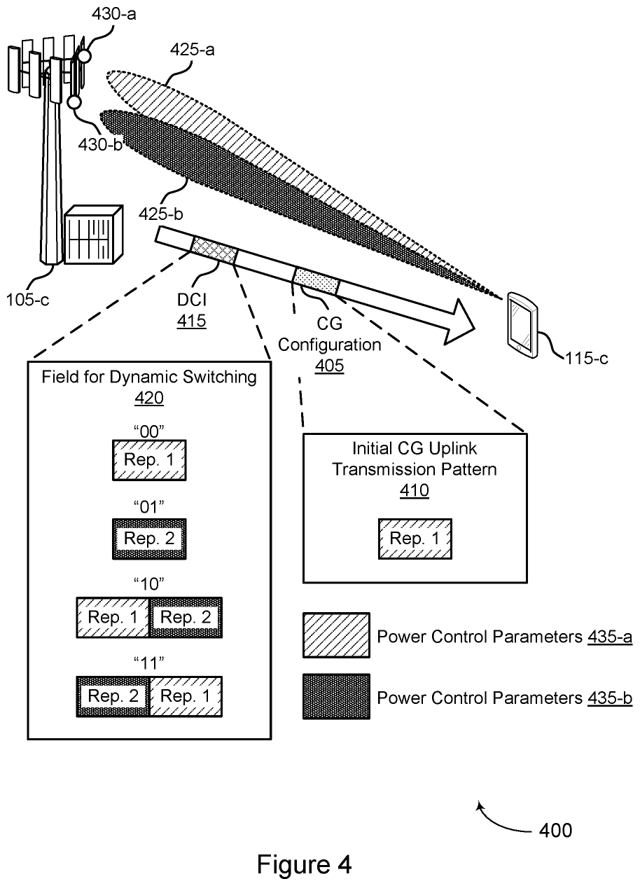

If the UE 115-a is configured with one set of power control parameters 235-a but receives a DCI field for dynamic switching indicating a second SRS resource set or a second set of power control parameters 235-b (for example, if the field for dynamic switching includes a bit value of ‘01,’ ‘10,’ or ‘11’), the UE 115-a may operate in accordance with techniques described herein. In some examples, the UE 115-a may determine an error case based on receiving a DCI field for dynamic switching that does not align with the CG configuration 205. Additionally or alternatively, the UE 115-a may ignore the DCI field for dynamic switching and may transmit the CG uplink transmission 225 in accordance with the first set of power control parameters 235-a and the first SRS resource set configured by the CG configuration 205. In some other examples, the UE 115-a may determine the second set of power control parameters 235-b and may transmit the CG uplink transmission 225 in accordance with the second set of power control parameters 235-b and the second SRS resource set indicated by the DCI field for dynamic switching. Examples in which the initial CG uplink transmission indicates one set of power control parameters 235 for sTRP and the CG uplink retransmission request indicates two sets of power control parameters 235 for mTRP are described in more detail herein, including with reference to FIG. 4.

FIG. 3 illustrates an example of a wireless communications system 300 that supports power control parameter configuration for CGs in accordance with aspects of the present disclosure. The wireless communications system 300 may implement or be implemented to realize aspects of the wireless communications system 100, the wireless communications system 200, or both. For example, the wireless communications system 300 may support communications between a UE 115-b and a base station 105-b, which may be examples of corresponding devices described with reference to FIG. 1 and FIG. 2. The base station 105-b may configure the UE 115-b with a CG configuration 305 for a CG uplink transmission using one or multiple beams 325 with corresponding power control parameters 335 that are associated with one or multiple SRS resource sets. The SRS resource sets may support transmission of uplink data to different TRPs 330 at the base station 105-b or different TRPs 330 located at different base stations 105. The base station 105-b may transmit DCI signaling 315 which may include a field for dynamic switching 320. In some examples, the field for dynamic switching 320 may include a value that does not align with the configured parameters for the CG configuration 305. As such, the UE 115-b may use techniques described herein to determine the beam(s) 325 and corresponding set(s) of power control parameters 335 for CG uplink transmission.

In the wireless communications system 300, the base station 105-b may configure the UE 115-b with a CG configuration 305 for CG uplink transmissions. For example, the base station 105-b may transmit the CG configuration 305 which may indicate a CG configuration of Type 1 or Type 2 to the UE 115-b as described in more detail herein, with reference to FIG. 2. The CG configuration 305 may also include signaling indicative of an initial CG uplink transmission pattern 310. In some examples, the initial CG uplink transmission pattern 310 may indicate a pattern such that the UE 115-b may transmit a first CG uplink transmission repetition using a first set of power control parameters 335-a via a beam 325-a corresponding to a first SRS resource set and may transmit a second CG uplink transmission repetition using a second set of power control parameters 335-b via a beam 325-b corresponding to a second SRS resource set.

In some examples, the base station 105-b may transmit the DCI signaling 315 to the UE 115-b. For example, the DCI signaling 315 may be an example of an activation DCI used to activate the CG configuration for an uplink transmission (for example, for a Type 2 CG) or may be an example of a scheduling DCI which the base station 105-b may use to request a retransmission of a CG uplink transmission (for example, for either Type 1 CG or Type 2 CG). If the DCI signaling 315 is an activation DCI, the activation DCI may include a CRC value scrambled with a CS-RNTI, an NDI field set to 0, an RV field set to 0, and a HARQ process number (HPN) field which may indicate the HPN of the initial CG uplink transmission. If the DCI signaling 315 is a scheduling DCI, the scheduling DCI may include a CRC value scrambled with a CS-RNTI, an NDI field set to 1 to indicate that the scheduling DCI is scheduling a retransmission of a CG uplink transmission, and an HPN field indicating the HPN of the initial CG uplink transmission (indicating for which message the retransmission is scheduled).

The DCI signaling 315 may indicate one or multiple sets of power control parameters 335, one or more SRS resources in each of one or multiple SRS resource sets, or both, as well as an order for the power control parameters 335, SRS resource sets, or both. For example, the DCI signaling 315 may include the field for dynamic switching 320 which may be a two-bit sized bit field used to indicate an updated CG uplink transmission pattern. For example, if the bit field for dynamic switching 320 is of a first value (for example, ‘00’), the bit field may indicate to the UE 115-b to use the first SRS resource set corresponding to the first set of power control parameters 335-a and the first beam 325-a for sTRP CG uplink transmissions to the TRP 330-a. If the bit field for dynamic switching 320 is of a second value (for example, ‘01’), the bit field may indicate to the UE 115-b to use the second SRS resource set corresponding to the second set of power control parameters 335-b and the second beam 325-b for sTRP CG uplink transmission to the TRP 330-b. If the bit field for dynamic switching 320 is of a third value (for example, ‘10’), the bit field may indicate to the UE 115-b an mTRP pattern such that a first CG uplink transmission repetition is transmitted using the first SRS resource set corresponding to the first set of power control parameters 335-a via the first beam 325-a to the TRP 330-a and a second CG uplink transmission repetition is transmitted using the second SRS resource set corresponding to the second set of power control parameters 335-b via the second beam 325-b to the TRP 330-b in a first repetition order. If the bit field for dynamic switching 320 is of a fourth value (for example, ‘11’), the bit field may indicate to the UE 115-b a different mTRP order of the CG uplink transmission pattern than the third bit field value (for example, a second repetition order in which the second SRS resource set and second set of power control parameters 335-b are used before the first SRS resource set and first set of power control parameters 335-a). As such, the field for dynamic switching 320 indicates whether the UE 115-b may apply one or two sets of power control parameters 335 (such as P0, alpha, PL-RS, and the close loop index), one or two TPMIs, and one or two beams 325 for the CG uplink transmission or the CG uplink retransmission.

As illustrated in FIG. 3, the initial CG uplink transmission pattern 310 may have a pattern indicative of a field for dynamic switching 320 value of ‘10.’ That is, the base station 105-b may initially configure the UE 115-b with two sets of power control parameters 335 which may be used for mTRP CG uplink transmission (for example, the first and the second RRC fields for p0-PUSCH-Alpha and powerControlLoopToUse are configured). In examples of CG uplink retransmission, however, the field for dynamic switching 320 may indicate an sTRP CG uplink transmission. That is, the base station 105-b may configure the UE 115-b with the two SRS resource sets and two sets of power control parameters 335 in the CG configuration 305, but may transmit DCI signaling 315 including a field for dynamic switching 320 indicating one set of power control parameters 335 for CG uplink retransmission (for example, the base station 105-b indicates the UE 115-b to use one SRI field and one TPMI field). For instance, the field for dynamic switching 320 may be a value of ‘00’ or ‘01’ while the UE 115-b is configured with both a first set of power control parameters 335-a and a second set of power control parameters 335-b.

If the base station 105-b configures the UE 115-b with the two SRS resource sets for codebook or non-codebook CG uplink transmissions and the first and second RRC fields p0-PUSCH-Alpha and powerControlLoopToUse are configured, but the field for dynamic switching 320 indicates one SRS resource set for CG uplink retransmission, the UE 115-b may operate in accordance with the techniques described herein. The UE 115-b may associate the first RRC-configured fields p0-PUSCH-Alpha and powerControlLoopToUse that are included in power control parameters 335-a with the first SRS resource set and may associate the second RRC-configured fields p0-PUSCH-Alpha and powerControlLoopToUse that are included in power control parameters 335-b with the second SRS resource set. Applying the first, second, or both the first and second RRC-configured fields p0-PUSCH-Alpha and powerControlLoopToUse may be determined from a DCI field (for example, the field for dynamic switching 320) of the scheduling DCI for a CG uplink retransmission. The base station 105-b may dynamically switch a TRP configuration, the power control parameters 335 for CG uplink transmission, the SRS resource sets for CG uplink transmission, or a combination thereof using a scheduling DCI as compared to the parameters indicated by and used based on an activation message (for example, an activation DCI or RRC signaling). Such flexibility may support improved communication reliability, power savings, or both at the UE 115-b (for example, as compared to supporting TRP, SRS resource set, and power control parameter 335 configuration at activation time but not retransmission scheduling time).

As such, the UE 115-b may determine to apply the first set of power control parameters 335-a, the second set of power control parameters 335-b, or a combination thereof based on the bit value received from the field for dynamic switching 320. For example, if the bit field for dynamic switching 320 for the CG uplink retransmission is of the value ‘00,’ this value may indicate to the UE 115-b to use the first SRS resource set corresponding to the first set of power control parameters 335-a for the CG uplink retransmission. If the bit field for dynamic switching 320 for the CG uplink retransmission is of the value ‘01,’ this value may indicate to the UE 115-b to use the second SRS resource set corresponding to the second set of power control parameters 335-b. If the bit field for dynamic switching 320 for the CG uplink retransmission is of the value ‘10,’ this value may indicate to the UE 115-b to use both the first SRS resource set associated with the power control parameters 335-a and the second SRS resource set associated with the power control parameters 335-b using a first repetition order. If the bit field for dynamic switching 320 for the CG uplink retransmission is of the value ‘11,’ this value may indicate to the UE 115-b to use both the first SRS resource set associated with the power control parameters 335-a and the second SRS resource set associated with the power control parameters 335-b using a second repetition order. Additional or alternative mappings of bit values to SRS resource sets and power control parameters 335 may be supported by the DCI signaling 315, the field for dynamic switching 320, or both.

FIG. 4 illustrates an example of a wireless communications system 400 that supports power control parameter configuration for CGs in accordance with aspects of the present disclosure. The wireless communications system 400 may implement or be implemented to realize aspects of the wireless communications system 100, the wireless communications system 200, the wireless communications system 300, or a combination thereof. For example, the wireless communications system 400 may support communications between a UE 115-c and a base station 105-c, which may be examples of corresponding devices described with reference to FIGS. 1-3. The base station 105-c may configure the UE 115-c with a CG configuration 405 for a CG uplink transmission using one or multiple beams 425 (for example, a beam 425-a and a beam 425-b) with corresponding power control parameters 435 that are associated with one or multiple SRS resource sets. The UE 115-c may transmit uplink data to multiple TRPs 430 (for example, a TRP 430-a and a TRP 430-b) located at the base station 105-c or multiple TRPs 430 located at multiple base stations 105 based on the configuration from the base station 105-c. In some examples, the base station 105-c may transmit DCI signaling 415 which may include a field for dynamic switching 420 with a value that does not align with the configured parameters for the CG configuration 405. As such, the UE 115-c may use techniques described herein to determine which beam(s) 435 and corresponding power control parameter(s) 435 to use for CG uplink transmission.

In the wireless communications system 400, the base station 105-c may configure the UE 115-c with a CG configuration 405 for CG uplink transmissions. For example, the base station 105-c may transmit the CG configuration 405 which may indicate a CG configuration of Type 1 or Type 2 to the UE 115-c as described in more detail herein, with reference to FIG. 2. The CG configuration 405 may also include signaling indicative of an initial CG uplink transmission pattern 410. In some examples (as illustrated in FIG. 4), the initial CG uplink transmission pattern 410 may indicate a pattern such that the UE 115-c may transmit CG uplink transmission repetitions using a first set of power control parameters 435-a via a beam 425-a corresponding to a first SRS resource set for sTRP CG uplink transmission.

In some examples, the base station 105-c may transmit the DCI signaling 415 to the UE 115-c. For example, the DCI signaling 415 may be an example of an activation DCI used to activate the CG uplink transmission for Type 2 CG or may be an example of a scheduling DCI scheduling a retransmission of a CG uplink transmission for either Type 1 CG or Type 2 CG.

The DCI signaling 415 may include the field for dynamic switching 420 which—in some examples—may be a two-bit sized bit field used to indicate a CG uplink transmission pattern to the UE 115-c. Different values of the bit field for dynamic switching 420 may indicate different patterns of CG uplink transmission repetitions, as described with reference to FIGS. 2 and 3. As such, the field for dynamic switching 420 may indicate whether the UE 115-c applies one or two sets of power control parameters 435 (such as P0, alpha, PL-RS, and the close loop index), one or two TPMIs, and one or two beams 425 for the CG uplink transmission (for example, an initial transmission or retransmission).

As illustrated in FIG. 4, the initial CG uplink transmission pattern 410 may have a pattern indicative of a field for dynamic switching 420 value of ‘00.’ That is, the base station 105-c may configure the UE 115-c with two SRS resource sets and one set of power control parameters 435 (for example, the power control parameters 435-a) which the UE 115-c may use for an sTRP CG uplink transmission (for example, using the first p0-PUSCH-Alpha and powerControlLoopToUse configured via RRC signaling). In some examples, however, the field for dynamic switching 420 may indicate an mTRP CG uplink transmission. That is, the base station 105-c may configure the UE 115-c with the one set of power control parameters 435-a, but the field for dynamic switching 420 may indicate two sets of power control parameters 435 or at least a second set of power control parameters 435 (such as the power control parameters 435-b). For instance, the field for dynamic switching 420 may be a value of ‘01,’ ‘10,’ or ‘11’ indicating the use of at least the power control parameters 435-b while the UE 115-c is configured with the power control parameters 435-a (but not the power control parameters 435-b).

If the UE 115-c is configured with two SRS resource sets for codebook or non-codebook CG uplink transmissions, and the given CG configuration 405 configures one set of power control parameters 435-a), but the DCI signaling 415 includes a field for dynamic switching 420 that indicates the use of two sets of power control parameters 435 (or at least a second set of power control parameters 435-b), the UE 115-c may operate in accordance with techniques described herein. The DCI signaling 415 may be an example of an activation DCI for a Type 2 CG or may be an example of a scheduling DCI for retransmission for a Type 1 CG or a Type 2 CG.

In some examples, the UE 115-c may determine an error case based on receiving the DCI field for dynamic switching 420 that does not align with the CG configuration 405. For example, the CG configuration 405 may configure the UE 115-c with a set of power control parameters 435-a, and the UE 115-c may predict the value of the field for dynamic switching 420 to be set to ‘00’ (corresponding to the configured set of power control parameters 435-a). If the field for dynamic switching 420 is of a different value than predicted (for example, ‘01,’ ‘10,’ or ‘11’), the UE 115-c may detect an error. The error may correspond to an error in receiving the DCI signaling 415, an error in the CG configuration 405, or another error. In some such examples, the UE 115-c may transmit a signal that includes an error indication to the base station 105-c in response to the field for dynamic switching 420 being a value corresponding to non-configured parameters (for example, a value other than ‘00’). In some examples, the UE 115-c may transmit the CG uplink transmission repetitions using the power control parameters 435-a configured by the RRC signaling despite the error detection (for example, using the first p0-PUSCH-Alpha and powerControlLoopToUse fields configured in the CG configuration 405).

Additionally or alternatively, the UE 115-c may ignore the DCI field for dynamic switching 420 and may transmit the CG uplink transmission in accordance with the first set of power control parameters and the first SRS resource set. For example, the UE 115-c may refrain from using the field for dynamic switching 420 based on the CG configuration 405 failing to indicate a second set of power control parameters 435-b. That is, the UE 115-c may assume that CG uplink transmission repetitions are associated with the first SRS resource set and the first set of power control parameters 435-a based on the CG configuration 405 regardless of the field for dynamic switching 420. The UE 115-c may transmit the CG uplink transmission repetitions using the power control parameters 435-a (for example, the first p0-PUSCH-Alpha and powerControlLoopToUse fields configured in the CG configuration 405) whether the field for dynamic switching 420 indicates ‘00,’ ‘01,’ ‘10,’ or ‘11.’

In some other examples, the UE 115-c may use the SRS resource set configuration indicated in the field for dynamic switching 420 even in examples in which the CG configuration 405 fails to configure the UE 115-c with a second set of power control parameters 435-b for a second SRS resource set. That is, the field for dynamic switching 420 may indicate a second set of power control parameters 435 (for example, the field for dynamic switching 420 may include a value of ‘01’, ‘10’, or ‘11’) and the UE 115-c may decode the field and transmit a CG uplink transmission based on the value of the field for dynamic switching 420.

The UE 115-c may determine a first set of power control parameters 435-a to associate with the first SRS resource set and a second set of power control parameters 435-b to associate with the second SRS resource set. In some examples, the UE 115-c may determine the first set of power control parameters 435-a based on the RRC configured fields p0-PUSCH-Alpha and powerControlLoopToUse indicated in the CG configuration 405 (for example, associate the first SRS resource set with the power control parameters 435-a that were configured in the CG configuration 405). In some other examples, the UE 115-c may determine the first set of power control parameters 435-a based on an SRI included in the DCI signaling 415. For instance, the DCI signaling 415 may include a first SRI and a second SRI, and the UE 115-c may determine the first set of power control parameters 435-a based on the first SRI included in the DCI signaling 415. That is, the first SRI field included in the DCI signaling 415 may be associated with a first set of power control parameters 435-a (for example, a first P0 value, a first alpha, a first closed loop index, and a first set of PL-RS). In some examples, if the first SRI field is present in the DCI signaling 415, the UE 115-c may determine the first set of power control parameters 435-a using the first SRI field and a set of SRI power control identifiers received via RRC signaling (for example, a set sri-PUSCH-PowerControl fields). Alternatively, if the DCI signaling 415 fails to include a first SRI field (for example, if the first SRI field is not present in—or is otherwise absent from—the DCI signaling 415), the UE 115-c may determine the first set of power control parameters 435-a from the sri-PUSCH-PowerControl field with the lowest ID in the set of the SRI power control identifiers for the first SRS resource set. In some examples, the UE 115-c may use an alternative selection criterion to the lowest ID, such as a highest ID, an algorithm for selecting an ID from a list of IDs, or any other selection criteria.

In some examples, the UE 115-c may determine the second set of power control parameters 435-b in a similar methodology as used to determine the first set of power control parameters 435-a. For example, the UE 115-c may determine the second set of power control parameters 435-b based on the second SRI that may be included in the DCI signaling 415. That is, the second SRI field included in the DCI signaling 415 may be associated with a second set of power control parameters 435-b (for example, a second P0 value, a second alpha, a second closed loop index, and a second set of PL-RS). In some examples, if the second SRI field is present in the DCI signaling 415, the UE 115-c may determine the second set of power control parameters 435-b using the second SRI field and a set of SRI power control identifiers received via the RRC signaling (for example, a set sri-PUSCH-PowerControl fields). Alternatively, if the DCI signaling 415 fails to include a second SRI field (for example, if the second SRI field is not present in—or is otherwise absent from—the DCI signaling 415), the UE 115-c may determine the second set of power control parameters 435-b from the sri-PUSCH-PowerControl field with the lowest ID (or another ID based on a specific selection criterion) in the set of the SRI power control identifiers for the second SRS resource set.

The UE 115-c may use one or more of the above described techniques for determining the first set of power control parameters 435-a and the second set of power control parameters 435-b for CG uplink transmission. In some examples, the UE 115-c may be programmed to operate according to a specific technique. In some other examples, the base station 105-c may configure the UE 115-c to operate according to a technique (for example, via RRC signaling). For example, the base station 105-c may enable the UE 115-c to trigger an error if the field for dynamic switching 420 fails to align with the CG configuration 405, to ignore the field for dynamic switching 420, or to determine a second set of power control parameters 435-b if the field for dynamic switching 420 fails to align with the CG configuration 405. Additionally or alternatively, the base station 105-c may enable the UE 115-c to use a specific technique for determining the second set of power control parameters 435-b if the field for dynamic switching 420 fails to align with the CG configuration 405. In yet some other examples, the UE 115-c may dynamically select a technique to use. Additionally or alternatively, the UE 115-c may use different techniques for Type 1 CG, Type 2 CG, activation DCI, scheduling DCI for retransmissions, or any combination thereof.

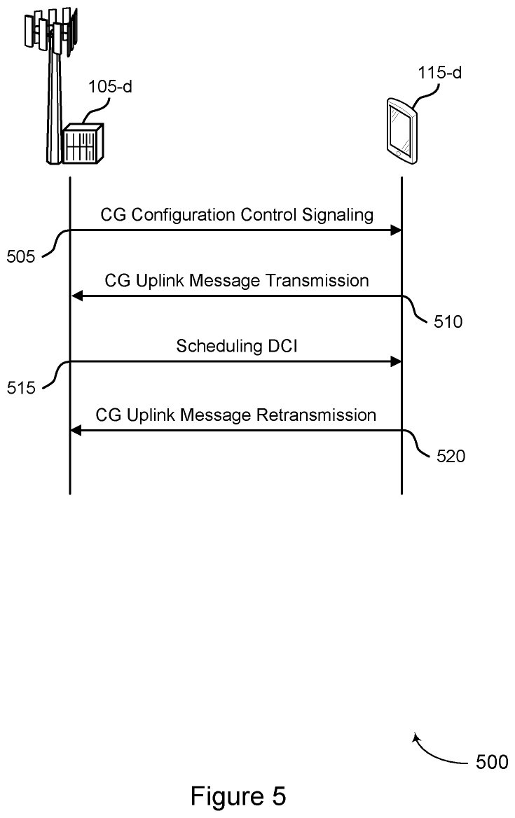

FIG. 5 illustrates an example of a process flow 500 that supports power control parameter configuration for CGs in accordance with aspects of the present disclosure. In some examples, the process flow 500 may implement aspects of the wireless communications system 100, the wireless communications system 200, the wireless communications system 300, the wireless communications system 400, or a combination thereof. For example, the process flow 500 may support communications between a UE 115-d and a base station 105-d, which may be examples of corresponding devices described with reference to FIGS. 1-4. Alternative examples of the following may be implemented, in which some steps are performed in a different order than described or are not performed at all. In some implementations, steps may include additional features not mentioned below, or further steps may be added. In addition, while the process flow 500 shows processes between the base station 105-d and the UE 115-d, these processes may occur between any number of devices.

At 505, the UE 115-d may receive CG configuration control signaling from the base station 105-d. For example, the base station 105-d may configure the UE 115-d with a CG configuration for semi-persistent scheduling of CG-based uplink transmissions. The CG configuration control signaling may configure a first SRS resource set, a second SRS resource set, a first set of power control parameters, and a second set of power control parameters to be used for CG uplink transmission according to a CG configuration. In some examples, the CG configuration control signaling may be an example of RRC signaling, such as a ConfiguredGrantConfig.

In some examples, CG configuration control signaling may activate the CG configuration at the UE 115-d, indicating to the UE 115-d to proceed with a CG uplink transmission message, such that the CG uplink message is transmitted based on the base station 105-d activating the CG configuration. In such examples, the CG configuration may correspond to a Type 1 CG and RRC signaling, such as an rrc-ConfiguredUplinkGrant, may activate the CG configuration. In some examples, the CG configuration may correspond to a Type 2 CG. In such examples, the UE 115-d may receive first DCI activating the CG configuration, and the UE 115-d may transmit the CG uplink message based on the first DCI activating the CG configuration. In such examples, the CG configuration control signaling may include RRC signaling and the first DCI. The RRC signaling included in the CG control signaling for the Type 2 CG may include the first set of power control parameters and the second set of power control parameters, and the first DCI may indicate the first SRS resource set, the second SRS resource set, or both.

At 510, the UE 115-d may transmit the CG uplink message to the base station 105-d. The UE 115-d may configure the CG uplink message transmission based on the CG configuration control signaling that indicated the CG configuration type, the first and second SRS resource sets, and the first and second sets of power control parameters.

At 515, the UE 115-d may receive a scheduling DCI which may indicate a retransmission of the CG uplink message according to the CG configuration. The scheduling DCI may indicate which of the sets of power control parameters to use for the retransmission. The scheduling DCI may include a bit field for dynamic switching which may indicate to the UE 115-d which of the SRS resource sets and the sets of power control parameters to use. In some examples, the bit field for dynamic switching may indicate for the UE 115-d to use the first set of power control parameters with the first SRS resource set for the CG uplink message retransmission based on a first value of the field for dynamic switching (for example, a value ‘00’). In some examples, the bit field for dynamic switching may indicate for the UE 115-d to use the second set of power control parameters with the second SRS resource set for the CG uplink message retransmission based on a second value of the field for dynamic switching (for example, a value ‘01’). In some examples, the bit field for dynamic switching may indicate for the UE 115-d to use both the first set of power control parameters with the first SRS resource set and the second set of power control parameters with the second SRS resource set according to a first order for the CG uplink message retransmission based on a third value of the field for dynamic switching (for example, a value ‘10’). In some examples, the bit field for dynamic switching may indicate for the UE 115-d to use both the first set of power control parameters with the first SRS resource set and the second set of power control parameters with the second SRS resource set according to a second order for the CG uplink message retransmission based on a fourth value of the field for dynamic switching (for example, a value ‘11’).

In some examples, the scheduling DCI may further include an HPN field which may indicate an HPN corresponding to the CG uplink message transmission based on the CG configuration and an NDI field that may indicate the scheduling DCI schedules a retransmission (such as the retransmission of the CG uplink message).

The UE 115-d may store an association between the two SRS resource sets and the two sets of power control parameters. For example, the UE 115-d may store or otherwise identify a first association between the first set of power control parameters and the first SRS resource set and a second association between the second set of power control parameters and the second SRS resource set. The UE 115-d may determine an order of retransmission for CG uplink transmission repetitions based on the associations, the scheduling DCI, and the field for dynamic switching.

At 520, the UE 115-d may retransmit the CG uplink message. The CG uplink message retransmission may be based on the scheduling DCI and the field for dynamic switching indicating which of the first and second sets of power control parameters and associated first and second SRS resource sets to use for the CG uplink message retransmission.

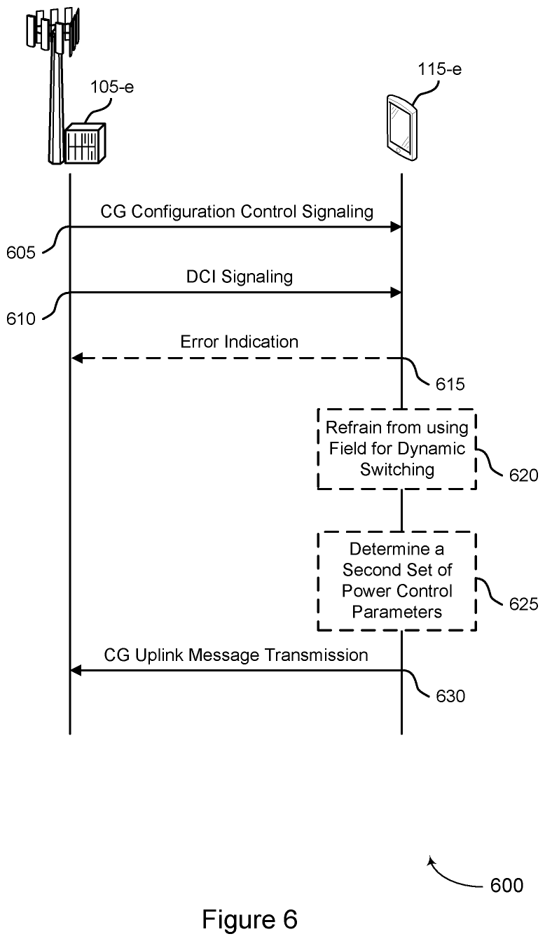

FIG. 6 illustrates an example of a process flow 600 that supports power control parameter configuration for CGs in accordance with aspects of the present disclosure. In some examples, the process flow 600 may implement aspects of the wireless communications system 100, the wireless communications system 200, the wireless communications system 300, the wireless communications system 400, or a combination thereof. For example, the process flow 600 may support communications between a UE 115-e and a base station 105-e, which may be examples of corresponding devices described with reference to FIGS. 1-4. Alternative examples of the following may be implemented in a manner in which some steps are performed in a different order than described or are not performed at all. In some examples, steps may include additional features not mentioned below, or further steps may be added. In addition, while the process flow 600 shows processes between the base station 105-e and the UE 115-e, these processes may occur between any number of devices.

At 605, the UE 115-e may receive RRC signaling from the base station 105-e. The RRC signaling may configure the UE 115-e with a first SRS resource set, a second SRS resource set, and a first set of power control parameters for CG uplink transmission according to a CG configuration. In some examples, the UE 115-e may activate the CG configuration based on receiving RRC signaling (for example, RRC signaling including a CG activation indication), and the UE 115-e may transmit an uplink message based on activating the CG configuration.

At 610, the UE 115-e may receive DCI signaling from the base station 105-e associated with the CG configuration. The DCI may also include a field for dynamic switching which may indicate at least a second set of power control parameters. In examples in which the CG configuration is a Type 1 CG, the DCI signaling may schedule retransmission of the CG uplink message. In some examples, the CG configuration may correspond to a Type 2 CG. In such examples, the UE 115-e may activate the CG configuration based on receiving the DCI signaling, and the UE 115-e may transmit the CG uplink message based on the UE 115-e activating the CG configuration. In alternative examples in which the CG configuration is the Type 2 CG, the DCI signaling may schedule retransmission of the CG uplink message.

At 615, the UE 115-e may transmit, in response to receiving the DCI signaling, a signal including an error indication based on the DCI signaling indicating at least the second set of power control parameters and the RRC signaling configuring the first set of power control parameters (but not the second set of power control parameters).

At 620, the UE 115-e may refrain from using the field for dynamic switching included in the DCI signaling based on the RRC signaling failing to configure the second set of power control parameters. Even if the field for dynamic switching indicates a second set of power control parameters, the UE 115-e may transmit the CG uplink message using the first set of power control parameters configured for the CG configuration.

At 625, the UE 115-e may determine the second set of power control parameters based on the DCI signaling indicating at least the second set of power control parameters. In some examples, the DCI signaling may include a first SRI and a second SRI and the UE 115-e may determine the second set of power control parameters based on the second SRI included in the DCI signaling. In some examples, the RRC signaling may include a set of SRI power control identifiers associated with the second SRS resource set, and the UE 115-e may determine the second set of power control parameters based on an SRI power control identifier from the set of SRI power control identifiers associated with the second SRS resource set and on a selection criterion (for example, the selection criteria may indicate to select the SRI power control identifier with the lowest ID). In some examples, the UE 115-e may determine the first set of power control parameters based on power control parameter fields in the RRC signaling. In some examples, the DCI signaling may include a first SRI and the UE 115-e may determine the first set of power control parameters based on the first SRI. In some examples, the RRC signaling may include a set of SRI power control identifiers associated with the first SRS resource set, and the UE 115-e may determine the first set of power control parameters based on an SRI power control identifier from the set of SRI power control identifiers associated with the first SRS resource set and on a selection criterion. In some examples, the UE 115-e may receive control signaling indicating to determine the second set of power control parameters if the RRC signaling fails to configure the second set of power control parameters and the DCI signaling indicates at least the second set of power control parameters, and the UE 115-e may determine the second set of power control parameters based on the control signaling.

At 630, the UE 115-e may transmit the CG uplink message based on the DCI signaling. If the UE 115-e refrains from determining the second set of power control parameters, the UE 115-e may transmit the CG uplink message using the first set of power control parameters with the first SRS resource set based on the RRC signaling indicating the first set of power control parameters. If the UE 115-e determines the second set of power control parameters, the UE 115-e may transmit the CG uplink message based on the DCI signaling and the CG configuration, such that the CG uplink transmission may be transmitted using at least the second set of power control parameters. The DCI signaling may also identify to the UE 115-e to transmit the CG uplink message with various repetition patterns. For examples, the DCI signaling may indicate to the UE 115-e to transmit a first repetition of the CG uplink message using the first set of power control parameters based on the DCI and the CG configuration and transmit a second repetition of the CG uplink message using the second set of power control parameters based on the DCI signaling. The DCI signaling may also indicate, to the UE 115-e using the field for dynamic switching, an order for transmitting the first repetition and the second repetition of the CG uplink message. For example, the UE 115-e may determine the order for transmitting the first repetition and the second repetition based on a value of the field for dynamic switching, such that the UE 115-e may transmit the first repetition and transmit the second repetition based on the determined order.

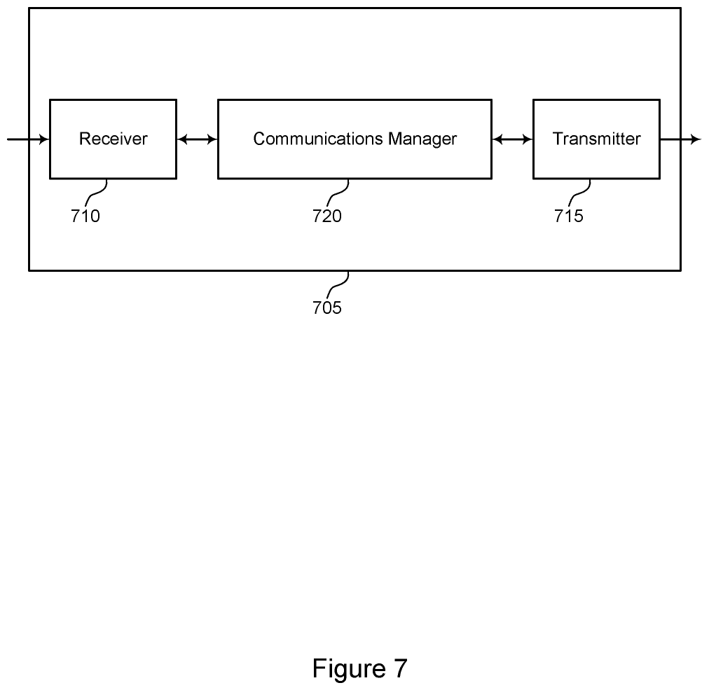

FIG. 7 shows a block diagram of a device 705 that supports power control parameter configuration for CGs in accordance with aspects of the present disclosure. The device 705 may be an example of aspects of a UE 115. The device 705 may include a receiver 710, a transmitter 715, and a communications manager 720. The communications manager 720 can be implemented, at least in part, by one or both of a modem and a processor. Each of these components may be in communication with one another (for example, via one or more buses).

The receiver 710 may provide a means for receiving information such as packets, user data, control information, or any combination thereof associated with various information channels (for example, control channels, data channels, information channels related to power control parameter configuration for CGs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (for example, control channels, data channels, information channels related to power control parameter configuration for CGs). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of power control parameter configuration for CGs. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (for example, in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally or alternatively, in some examples, the communications manager 720, the receiver 710, the transmitter 715, or various combinations or components thereof may be implemented in code (for example, as communications management software or firmware) executed by a processor. If implemented in code executed by a processor, the functions of the communications manager 720, the receiver 710, the transmitter 715, or various combinations or components thereof may be performed by a general-purpose processor, a DSP, a central processing unit (CPU), an ASIC, an FPGA, or any combination of these or other programmable logic devices (for example, configured as or otherwise supporting a means for performing the functions described in the present disclosure).

In some examples, the communications manager 720 may be configured to perform various operations (for example, receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations.

The communications manager 720 may support wireless communications in accordance with examples as disclosed herein. For example, the communications manager 720 may be configured as or otherwise support a means for receiving control signaling configuring a first sounding reference signal resource set, a second sounding reference signal resource set, and a configured grant configuration including a first set of power control parameters and a second set of power control parameters, for configured grant uplink transmission. The communications manager 720 may be configured as or otherwise support a means for transmitting an uplink message based on the configured grant configuration. The communications manager 720 may be configured as or otherwise support a means for receiving downlink control information scheduling a retransmission of the uplink message according to the configured grant configuration, the downlink control information indicating one or more of the first set of power control parameters or the second set of power control parameters. The communications manager 720 may be configured as or otherwise support a means for retransmitting the uplink message based on the downlink control information and using the indicated one or more of the first set of power control parameters or the second set of power control parameters with one or both of the first sounding reference signal resource set or the second sounding reference signal resource set.

Additionally or alternatively, the communications manager 720 may support wireless communications in accordance with examples as disclosed herein. For example, the communications manager 720 may be configured as or otherwise support a means for receiving radio resource control signaling configuring a first sounding reference signal resource set, a second sounding reference signal resource set, and a configured grant configuration including a first set of power control parameters for configured grant uplink transmission. The communications manager 720 may be configured as or otherwise support a means for receiving downlink control information associated with the configured grant configuration, the downlink control information indicating at least a second set of power control parameters different than the first set of power control parameters. The communications manager 720 may be configured as or otherwise support a means for transmitting an uplink message based on the downlink control information and using the first set of power control parameters associated with the first sounding reference signal resource set based on the radio resource control signaling configuring the first set of power control parameters.

Additionally or alternatively, the communications manager 720 may support wireless communications in accordance with examples as disclosed herein. For example, the communications manager 720 may be configured as or otherwise support a means for receiving radio resource control signaling configuring a first sounding reference signal resource set, a second sounding reference signal resource set, and a configured grant configuration including a first set of power control parameters for configured grant uplink transmission. The communications manager 720 may be configured as or otherwise support a means for receiving downlink control information associated with the configured grant configuration, the downlink control information indicating at least a second set of power control parameters different than the first set of power control parameters. The communications manager 720 may be configured as or otherwise support a means for transmitting an uplink message based on the downlink control information and the configured grant configuration, the uplink message being transmitted using at least the second set of power control parameters based on the downlink control information indicating at least the second set of power control parameters.

By including or configuring the communications manager 720, the device 705 (for example, a processor controlling or otherwise coupled to the receiver 710, the transmitter 715, the communications manager 720, or a combination thereof) may support techniques for reduced processing overhead, reduced power consumption, more efficient utilization of communication resources, or a combination thereof.

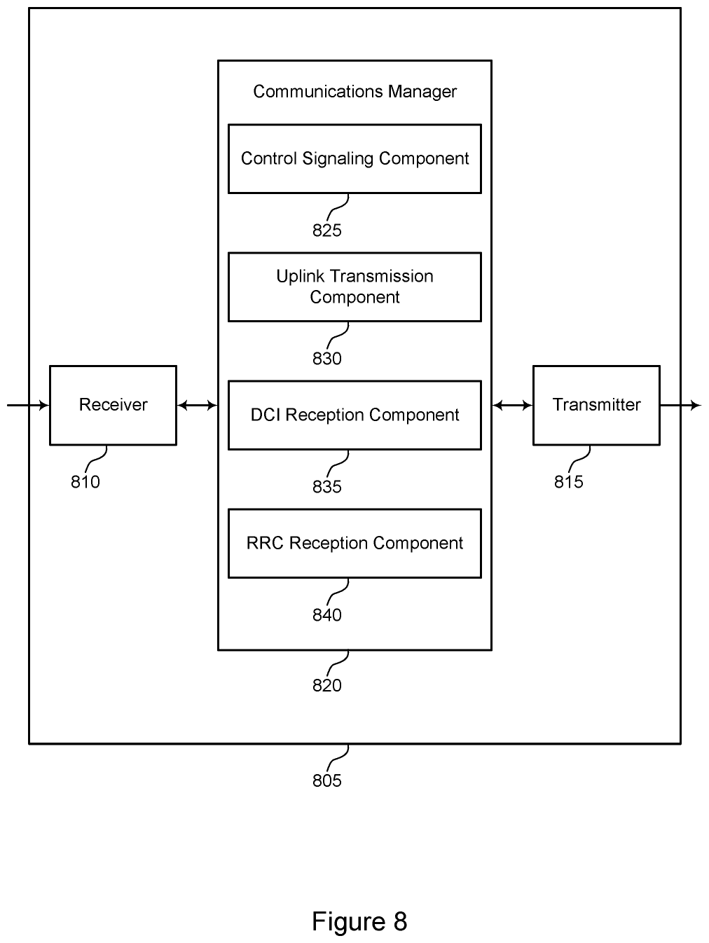

FIG. 8 shows a block diagram of a device 805 that supports power control parameter configuration for CGs in accordance with aspects of the present disclosure. The device 805 may be an example of aspects of a device 705 or a UE 115. The device 805 may include a receiver 810, a transmitter 815, and a communications manager 820. The communications manager 820 can be implemented, at least in part, by one or both of a modem and a processor. Each of these components may be in communication with one another (for example, via one or more buses).

The receiver 810 may provide a means for receiving information such as packets, user data, control information, or any combination thereof associated with various information channels (for example, control channels, data channels, information channels related to power control parameter configuration for CGs). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (for example, control channels, data channels, information channels related to power control parameter configuration for CGs). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of power control parameter configuration for CGs. For example, the communications manager 820 may include a control signaling component 825, an uplink transmission component 830, a DCI reception component 835, an RRC reception component 840, or any combination thereof. In some examples, the communications manager 820, or various components thereof, may be configured to perform various operations (for example, receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations.

The communications manager 820 may support wireless communications in accordance with examples as disclosed herein. The control signaling component 825 may be configured as or otherwise support a means for receiving control signaling configuring a first sounding reference signal resource set, a second sounding reference signal resource set, and a configured grant configuration including a first set of power control parameters and a second set of power control parameters, for configured grant uplink transmission. The uplink transmission component 830 may be configured as or otherwise support a means for transmitting an uplink message based on the configured grant configuration. The DCI reception component 835 may be configured as or otherwise support a means for receiving downlink control information scheduling a retransmission of the uplink message according to the configured grant configuration, the downlink control information indicating one or more of the first set of power control parameters or the second set of power control parameters. The uplink transmission component 830 may be configured as or otherwise support a means for retransmitting the uplink message based on the downlink control information and using the indicated one or more of the first set of power control parameters or the second set of power control parameters with one or both of the first sounding reference signal resource set or the second sounding reference signal resource set.

Additionally or alternatively, the communications manager 820 may support wireless communications in accordance with examples as disclosed herein. The RRC reception component 840 may be configured as or otherwise support a means for receiving radio resource control signaling configuring a first sounding reference signal resource set, a second sounding reference signal resource set, and a configured grant configuration including a first set of power control parameters for configured grant uplink transmission. The DCI reception component 835 may be configured as or otherwise support a means for receiving downlink control information associated with the configured grant configuration, the downlink control information indicating at least a second set of power control parameters different than the first set of power control parameters. The uplink transmission component 830 may be configured as or otherwise support a means for transmitting an uplink message based on the downlink control information and using the first set of power control parameters associated with the first sounding reference signal resource set based on the radio resource control signaling configuring the first set of power control parameters.

Additionally or alternatively, the communications manager 820 may support wireless communications in accordance with examples as disclosed herein. The RRC reception component 840 may be configured as or otherwise support a means for receiving radio resource control signaling configuring a first sounding reference signal resource set, a second sounding reference signal resource set, and a configured grant configuration including a first set of power control parameters for configured grant uplink transmission. The DCI reception component 835 may be configured as or otherwise support a means for receiving downlink control information associated with the configured grant configuration, the downlink control information indicating at least a second set of power control parameters different than the first set of power control parameters. The uplink transmission component 830 may be configured as or otherwise support a means for transmitting an uplink message based on the downlink control information and the configured grant configuration, the uplink message being transmitted using at least the second set of power control parameters based on the downlink control information indicating at least the second set of power control parameters.

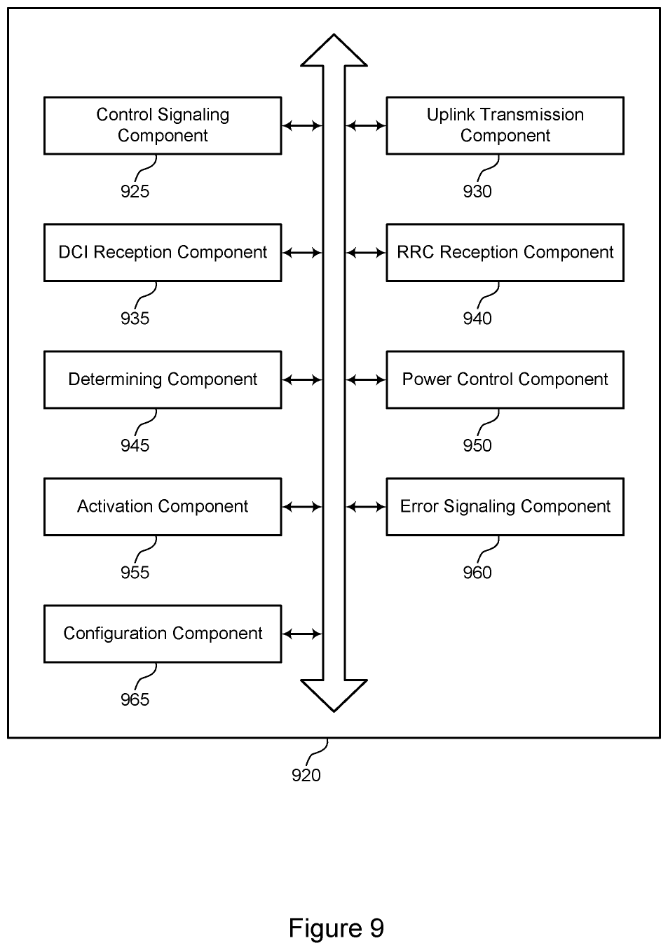

FIG. 9 shows a block diagram of a communications manager 920 that supports power control parameter configuration for CGs in accordance with aspects of the present disclosure. The communications manager 920, or various components thereof, may be an example of means for performing various aspects of power control parameter configuration for CGs. For example, the communications manager 920 may include a control signaling component 925, an uplink transmission component 930, a DCI reception component 935, an RRC reception component 940, a determining component 945, a power control component 950, an activation component 955, an error signaling component 960, a configuration component 965, or any combination thereof. Each of these components may communicate, directly or indirectly, with one another (for example, via one or more buses).

The communications manager 920 may support wireless communications in accordance with examples as disclosed herein. The control signaling component 925 may be configured as or otherwise support a means for receiving control signaling configuring a first sounding reference signal resource set, a second sounding reference signal resource set, and a configured grant configuration including a first set of power control parameters and a second set of power control parameters, for configured grant uplink transmission. The uplink transmission component 930 may be configured as or otherwise support a means for transmitting an uplink message based on the configured grant configuration. The DCI reception component 935 may be configured as or otherwise support a means for receiving downlink control information scheduling a retransmission of the uplink message according to the configured grant configuration, the downlink control information indicating one or more of the first set of power control parameters or the second set of power control parameters. In some examples, the uplink transmission component 930 may be configured as or otherwise support a means for retransmitting the uplink message based on the downlink control information and using the indicated one or more of the first set of power control parameters or the second set of power control parameters with one or both of the first sounding reference signal resource set according or the second sounding reference signal resource set according to the downlink control information.

In some examples, the determining component 945 may be configured as or otherwise support a means for determining to use one or both of the first sounding reference signal resource set or the second sounding reference signal resource set based on the downlink control information, a first association between the first set of power control parameters and the first sounding reference signal resource set, and a second association between the second set of power control parameters and the second sounding reference signal resource set, in which the retransmitting is further based on the determining.

In some examples, the downlink control information includes a field for dynamic switching, and the determining component 945 may be configured as or otherwise support a means for determining to use. In some examples, the downlink control information includes a field for dynamic switching, and the power control component 950 may be configured as or otherwise support a means for the first set of power control parameters with the first sounding reference signal resource set based on a first value of the field for dynamic switching. In some examples, the downlink control information includes a field for dynamic switching, and the power control component 950 may be configured as or otherwise support a means for the second set of power control parameters with the second sounding reference signal resource set based on a second value of the field for dynamic switching. In some examples, the downlink control information includes a field for dynamic switching, and the power control component 950 may be configured as or otherwise support a means for both the first set of power control parameters with the first sounding reference signal resource set and the second set of power control parameters with the second sounding reference signal resource set according to a first order based on a third value of the field for dynamic switching. In some examples, the downlink control information includes a field for dynamic switching, and the power control component 950 may be configured as or otherwise support a means for both the first set of power control parameters with the first sounding reference signal resource set and the second set of power control parameters with the second sounding reference signal resource set according to a second order based on a fourth value of the field for dynamic switching. In some examples, the downlink control information includes a field for dynamic switching, and the determining component 945 may be configured as or otherwise support a means for in which the retransmitting is further based on the determining.

In some examples, the activation component 955 may be configured as or otherwise support a means for activating the configured grant configuration based on receiving the control signaling, in which the uplink message is transmitted based on activating the configured grant configuration.

In some examples, the configured grant configuration corresponds to a Type 1 configured grant. In some examples, the control signaling includes radio resource control signaling.

In some examples, the DCI reception component 935 may be configured as or otherwise support a means for receiving first downlink control information activating the configured grant configuration, in which the uplink message is transmitted based on the first downlink control information activating the configured grant configuration, in which the control signaling includes radio resource control signaling and the first downlink control information, and in which the downlink control information scheduling the retransmission includes second downlink control information.

In some examples, the configured grant configuration corresponds to a Type 2 configured grant. In some examples, the radio resource control signaling includes the first set of power control parameters and the second set of power control parameters. In some examples, the first downlink control information indicates one or more sounding reference signal resources of one or both of the first sounding reference signal resource set or the second sounding reference signal resource set.

In some examples, the downlink control information further includes a hybrid automatic repeat request process number field indicating a hybrid automatic repeat request process number corresponding to the uplink message transmitted based on the configured grant configuration and a new data indicator field indicating that the downlink control information schedules the retransmission of the uplink message.

Additionally or alternatively, the communications manager 920 may support wireless communications in accordance with examples as disclosed herein. The RRC reception component 940 may be configured as or otherwise support a means for receiving radio resource control signaling configuring a first sounding reference signal resource set, a second sounding reference signal resource set, and a configured grant configuration including a first set of power control parameters for configured grant uplink transmission. In some examples, the DCI reception component 935 may be configured as or otherwise support a means for receiving downlink control information associated with the configured grant configuration, the downlink control information indicating at least a second set of power control parameters different than the first set of power control parameters. In some examples, the uplink transmission component 930 may be configured as or otherwise support a means for transmitting an uplink message based on the downlink control information and using the first set of power control parameters associated with the first sounding reference signal resource set based on the radio resource control signaling configuring the first set of power control parameters.

In some examples, the error signaling component 960 may be configured as or otherwise support a means for transmitting, in response to the downlink control information, a signal including an error indication based on the downlink control information indicating at least the second set of power control parameters and the radio resource control signaling configuring the first set of power control parameters.

In some examples, the downlink control information includes a field for dynamic switching indicating at least the second set of power control parameters, and the uplink transmission component 930 may be configured as or otherwise support a means for refraining from using the field for dynamic switching based on the radio resource control signaling failing to configure the second set of power control parameters, in which transmitting the uplink message using the first set of power control parameters is based on the refraining.

In some examples, the configured grant configuration corresponds to a Type 1 configured grant, and the activation component 955 may be configured as or otherwise support a means for activating the configured grant configuration based on receiving the radio resource control signaling, in which the uplink message is transmitted based on activating the configured grant configuration.

In some examples, the configured grant configuration corresponds to a Type 1 configured grant or a Type 2 configured grant. In some examples, the downlink control information schedules a retransmission of the uplink message. In some examples, transmitting the uplink message includes retransmitting the uplink message based on the downlink control information scheduling the retransmission.

In some examples, the activation component 955 may be configured as or otherwise support a means for activating the configured grant configuration based on receiving the downlink control information, in which the uplink message is transmitted based on activating the configured grant configuration.

In some examples, the configured grant configuration corresponds to a Type 2 configured grant. In some examples, the downlink control information further indicates one or more sounding reference signal resources of one or both of the first sounding reference signal resource set or the second sounding reference signal resource set.

Additionally or alternatively, the communications manager 920 may support wireless communications in accordance with examples as disclosed herein. In some examples, the RRC reception component 940 may be configured as or otherwise support a means for receiving radio resource control signaling configuring a first sounding reference signal resource set, a second sounding reference signal resource set, and a configured grant configuration including a first set of power control parameters for configured grant uplink transmission. In some examples, the DCI reception component 935 may be configured as or otherwise support a means for receiving downlink control information associated with the configured grant configuration, the downlink control information indicating at least a second set of power control parameters different than the first set of power control parameters. In some examples, the uplink transmission component 930 may be configured as or otherwise support a means for transmitting an uplink message based on the downlink control information and the configured grant configuration, the uplink message being transmitted using at least the second set of power control parameters based on the downlink control information indicating at least the second set of power control parameters.

In some examples, to support determining the second set of power control parameters, the determining component 945 may be configured as or otherwise support a means for determining the second set of power control parameters based on the second sounding reference signal resource indicator.

In some examples, to support determining the second set of power control parameters, the determining component 945 may be configured as or otherwise support a means for determining the second set of power control parameters based on a sounding reference signal resource indicator power control identifier of the set of multiple sounding reference signal resource indicator power control identifiers associated with the second sounding reference signal resource set and on a selection criterion.

In some examples, to support transmitting the uplink message, the uplink transmission component 930 may be configured as or otherwise support a means for transmitting a first repetition of the uplink message using the first set of power control parameters based on the downlink control information and the configured grant configuration. In some examples, to support transmitting the uplink message, the uplink transmission component 930 may be configured as or otherwise support a means for transmitting a second repetition of the uplink message using the second set of power control parameters based on the downlink control information and the determining.

In some examples, the determining component 945 may be configured as or otherwise support a means for determining the first set of power control parameters based on one or more power control parameter fields in the radio resource control signaling.

In some examples, the downlink control information includes a first sounding reference signal resource indicator, and the determining component 945 may be configured as or otherwise support a means for determining the first set of power control parameters based on the first sounding reference signal resource indicator.

In some examples, the radio resource control signaling includes a set of multiple sounding reference signal resource indicator power control identifiers associated with the first sounding reference signal resource set, and the determining component 945 may be configured as or otherwise support a means for determining the first set of power control parameters based on a sounding reference signal resource indicator power control identifier of the set of multiple sounding reference signal resource indicator power control identifiers associated with the first sounding reference signal resource set and on a selection criterion.

In some examples, the downlink control information includes a field for dynamic switching indicating the first set of power control parameters and the second set of power control parameters, and the determining component 945 may be configured as or otherwise support a means for determining an order for transmitting the first repetition and the second repetition based on a value of the field for dynamic switching, in which transmitting the first repetition and transmitting the second repetition are based on the determined order.

In some examples, the control signaling component 925 may be configured as or otherwise support a means for receiving control signaling indicating to determine the second set of power control parameters if the radio resource control signaling fails to configure the second set of power control parameters and the downlink control information indicates at least the second set of power control parameters, in which the determining is based on the control signaling.

In some examples, the activation component 955 may be configured as or otherwise support a means for activating the configured grant configuration based on receiving the radio resource control signaling, in which the uplink message is transmitted based on activating the configured grant configuration.

In some examples, the activation component 955 may be configured as or otherwise support a means for activating the configured grant configuration based on receiving the downlink control information, in which the uplink message is transmitted based on activating the configured grant configuration.

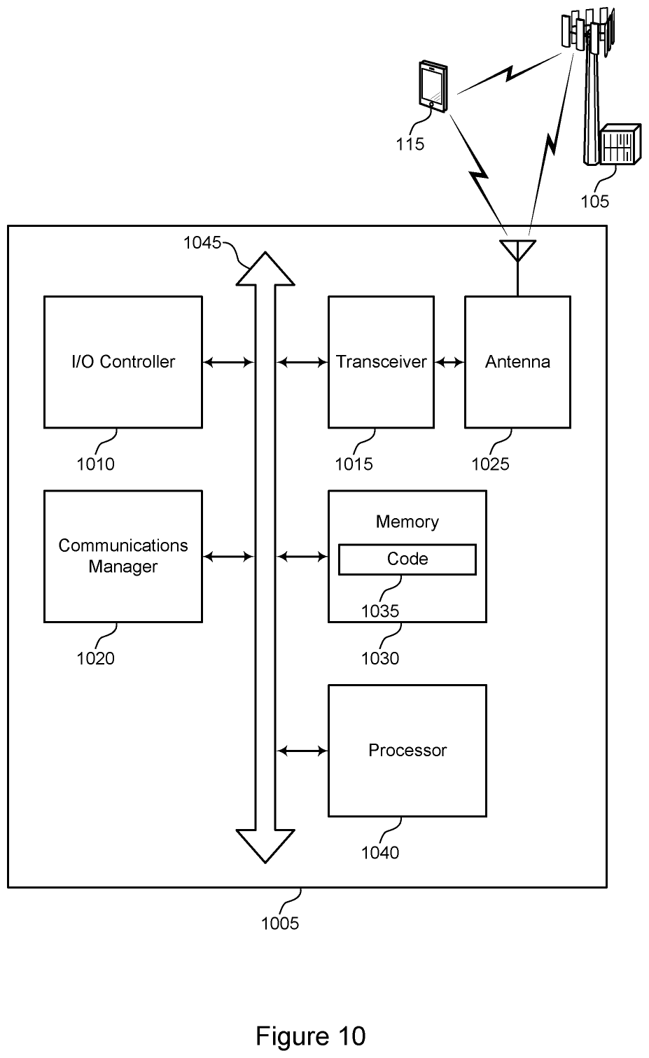

FIG. 10 shows a diagram of a system including a device 1005 that supports power control parameter configuration for CGs in accordance with aspects of the present disclosure. The device 1005 may be an example of or include the components of a device 705, a device 805, or a UE 115. The device 1005 may communicate wirelessly with one or more base stations 105, UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (for example, operatively, communicatively, functionally, electronically, electrically) via one or more buses (for example, a bus 1045).

The I/O controller 1010 may manage input and output signals for the device 1005. The I/O controller 1010 may also manage peripherals not integrated into the device 1005. In some examples, the I/O controller 1010 may represent a physical connection or port to an external peripheral. In some examples, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some examples, the I/O controller 1010 may be implemented as part of a processor, such as the processor 1040. In some examples, a user may interact with the device 1005 via the I/O controller 1010 or via hardware components controlled by the I/O controller 1010.

In some examples, the device 1005 may include a single antenna 1025. However, in some other examples, the device 1005 may have more than one antenna 1025, which may be capable of concurrently transmitting or receiving multiple wireless transmissions. The transceiver 1015 may communicate bi-directionally, via the one or more antennas 1025, wired, or wireless links. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some examples, the code 1035 may not be directly executable by the processor 1040 but may cause a computer (for example, when compiled and executed) to perform functions described herein. In some examples, the memory 1030 may contain, among other things, a basic I/O system (BIOS) which may control basic hardware or software operation such as the interaction with peripheral components or devices.

The processor 1040 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 1040 may be configured to operate a memory array using a memory controller. In some other examples, a memory controller may be integrated into the processor 1040. The processor 1040 may be configured to execute computer-readable instructions stored in a memory (for example, the memory 1030) to cause the device 1005 to perform various functions (for example, functions or tasks supporting power control parameter configuration for CGs). For example, the device 1005 or a component of the device 1005 may include a processor 1040 and memory 1030 coupled to the processor 1040, the processor 1040 and memory 1030 configured to perform various functions described herein.

The communications manager 1020 may support wireless communications in accordance with examples as disclosed herein. For example, the communications manager 1020 may be configured as or otherwise support a means for receiving control signaling configuring a first sounding reference signal resource set, a second sounding reference signal resource set, and a configured grant configuration including a first set of power control parameters and a second set of power control parameters, for configured grant uplink transmission. The communications manager 1020 may be configured as or otherwise support a means for transmitting an uplink message based on the configured grant configuration. The communications manager 1020 may be configured as or otherwise support a means for receiving downlink control information scheduling a retransmission of the uplink message according to the configured grant configuration, the downlink control information indicating one or more of the first set of power control parameters or the second set of power control parameters. The communications manager 1020 may be configured as or otherwise support a means for retransmitting the uplink message based on the downlink control information and using the indicated one or more of the first set of power control parameters or the second set of power control parameters with one or both of the first sounding reference signal resource set or the second sounding reference signal resource set according to the downlink control information.

Additionally or alternatively, the communications manager 1020 may support wireless communications in accordance with examples as disclosed herein. For example, the communications manager 1020 may be configured as or otherwise support a means for receiving radio resource control signaling configuring a first sounding reference signal resource set, a second sounding reference signal resource set, and a configured grant configuration including a first set of power control parameters for configured grant uplink transmission. The communications manager 1020 may be configured as or otherwise support a means for receiving downlink control information associated with the configured grant configuration, the downlink control information indicating at least a second set of power control parameters different than the first set of power control parameters. The communications manager 1020 may be configured as or otherwise support a means for transmitting an uplink message based on the downlink control information and using the first set of power control parameters associated with the first sounding reference signal resource set based on the radio resource control signaling configuring the first set of power control parameters.

Additionally or alternatively, the communications manager 1020 may support wireless communications in accordance with examples as disclosed herein. For example, the communications manager 1020 may be configured as or otherwise support a means for receiving radio resource control signaling configuring a first sounding reference signal resource set, a second sounding reference signal resource set, and a configured grant configuration including a first set of power control parameters for configured grant uplink transmission. The communications manager 1020 may be configured as or otherwise support a means for receiving downlink control information associated with the configured grant configuration, the downlink control information indicating at least a second set of power control parameters different than the first set of power control parameters. The communications manager 1020 may be configured as or otherwise support a means for transmitting an uplink message based on the downlink control information and the configured grant configuration, the uplink message being transmitted using at least the second set of power control parameters based on the downlink control information indicating at least the second set of power control parameters.

By including or configuring the communications manager 1020, the device 1005 may support techniques for improved communication reliability, reduced latency reduced power consumption, more efficient utilization of communication resources, improved coordination between devices, and improved utilization of a processing capability

In some examples, the communications manager 1020 may be configured to perform various operations (for example, receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of power control parameter configuration for CGs, or the processor 1040 and the memory 1030 may be otherwise configured to perform or support such operations.

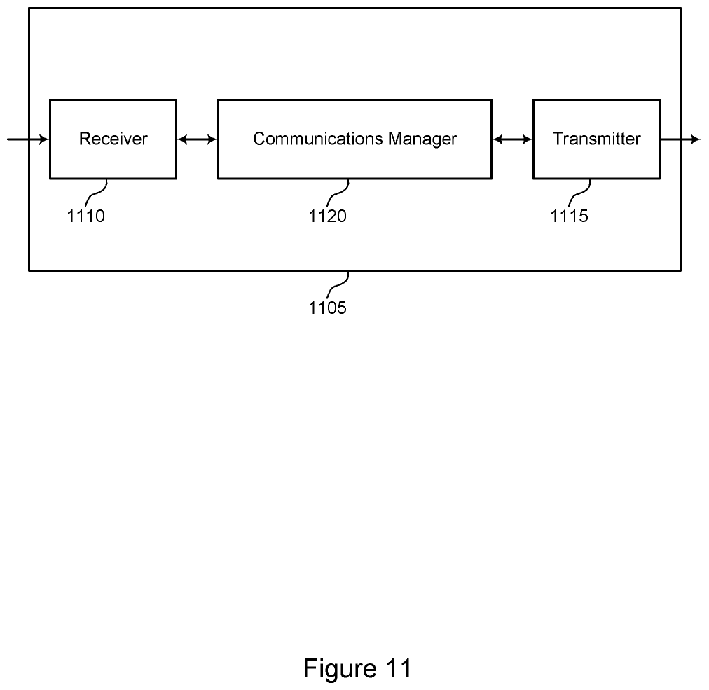

FIG. 11 shows a block diagram of a device 1105 that supports power control parameter configuration for CGs in accordance with aspects of the present disclosure. The device 1105 may be an example of aspects of a base station 105. The device 1105 may include a receiver 1110, a transmitter 1115, and a communications manager 1120. The communications manager 1120 can be implemented, at least in part, by one or both of a modem and a processor. Each of these components may be in communication with one another (for example, via one or more buses).

The receiver 1110 may provide a means for receiving information such as packets, user data, control information, or any combination thereof associated with various information channels (for example, control channels, data channels, information channels related to power control parameter configuration for CGs). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (for example, control channels, data channels, information channels related to power control parameter configuration for CGs). In some examples, the transmitter 1115 may be co-located with a receiver 1110 in a transceiver module. The transmitter 1115 may utilize a single antenna or a set of multiple antennas.

The communications manager 1120, the receiver 1110, the transmitter 1115, or various combinations thereof or various components thereof may be examples of means for performing various aspects of power control parameter configuration for CGs. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (for example, in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (for example, by executing, by the processor, instructions stored in the memory).

Additionally or alternatively, in some examples, the communications manager 1120, the receiver 1110, the transmitter 1115, or various combinations or components thereof may be implemented in code (for example, as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, or any combination of these or other programmable logic devices (for example, configured as or otherwise supporting a means for performing the functions described in the present disclosure).

In some examples, the communications manager 1120 may be configured to perform various operations (for example, receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations.

The communications manager 1120 may support wireless communications in accordance with examples as disclosed herein. For example, the communications manager 1120 may be configured as or otherwise support a means for transmitting, to a UE, control signaling configuring a first sounding reference signal resource set, a second sounding reference signal resource set, and a configured grant configuration including a first set of power control parameters and a second set of power control parameters, for configured grant uplink transmission. The communications manager 1120 may be configured as or otherwise support a means for transmitting, to the UE, downlink control information scheduling a retransmission of an uplink message according to the configured grant configuration based on a failure to receive the uplink message from the UE, the downlink control information indicating one or more of the first set of power control parameters or the second set of power control parameters. The communications manager 1120 may be configured as or otherwise support a means for receiving, from the UE, the retransmission of the uplink message using one or both of the first sounding reference signal resource set or the second sounding reference signal resource set based on the indicated one or more of the first set of power control parameters or the second set of power control parameters.

By including or configuring the communications manager 1120, the device 1105 (for example, a processor controlling or otherwise coupled with the receiver 1110, the transmitter 1115, the communications manager 1120, or a combination thereof) may support techniques for reduced processing overhead, reduced power consumption, more efficient utilization of communication resources, or a combination thereof.

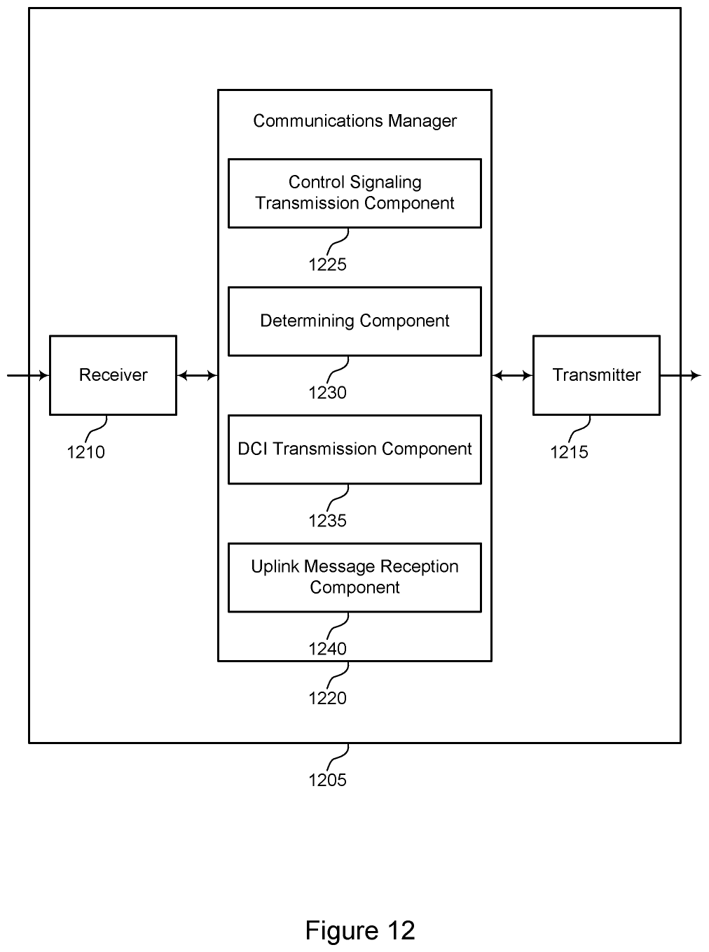

FIG. 12 shows a block diagram of a device 1205 that supports power control parameter configuration for CGs in accordance with aspects of the present disclosure. The device 1205 may be an example of aspects of a device 1105 or a base station 105. The device 1205 may include a receiver 1210, a transmitter 1215, and a communications manager 1220. The communications manager 1220 can be implemented, at least in part, by one or both of a modem and a processor. Each of these components may be in communication with one another (for example, via one or more buses).

The receiver 1210 may provide a means for receiving information such as packets, user data, control information, or any combination thereof associated with various information channels (for example, control channels, data channels, information channels related to power control parameter configuration for CGs). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (for example, control channels, data channels, information channels related to power control parameter configuration for CGs). In some examples, the transmitter 1215 may be co-located with a receiver 1210 in a transceiver module. The transmitter 1215 may utilize a single antenna or a set of multiple antennas.

The device 1205, or various components thereof, may be an example of means for performing various aspects of power control parameter configuration for CGs. For example, the communications manager 1220 may include a control signaling transmission component 1225, a determining component 1230, a DCI transmission component 1235, an uplink message reception component 1240, or any combination thereof. In some examples, the communications manager 1220, or various components thereof, may be configured to perform various operations (for example, receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations.

The communications manager 1220 may support wireless communications in accordance with examples as disclosed herein. The control signaling transmission component 1225 may be configured as or otherwise support a means for transmitting, to a UE, control signaling configuring a first sounding reference signal resource set, a second sounding reference signal resource set, and a configured grant configuration including a first set of power control parameters and a second set of power control parameters, for configured grant uplink transmission. In some examples, the determining component 1230 may be configured as or otherwise support a means for determining a failure to receive an uplink message from the UE based on the configured grant configuration. The DCI transmission component 1235 may be configured as or otherwise support a means for transmitting, to the UE, downlink control information scheduling a retransmission of the uplink message according to the configured grant configuration based on a failure to receive the uplink message from the UE, the downlink control information indicating one or more of the first set of power control parameters or the second set of power control parameters. The uplink message reception component 1240 may be configured as or otherwise support a means for receiving, from the UE, the retransmission of the uplink message using one or both of the first sounding reference signal resource set or the second sounding reference signal resource set based on the indicated one or more of the first set of power control parameters or the second set of power control parameters.

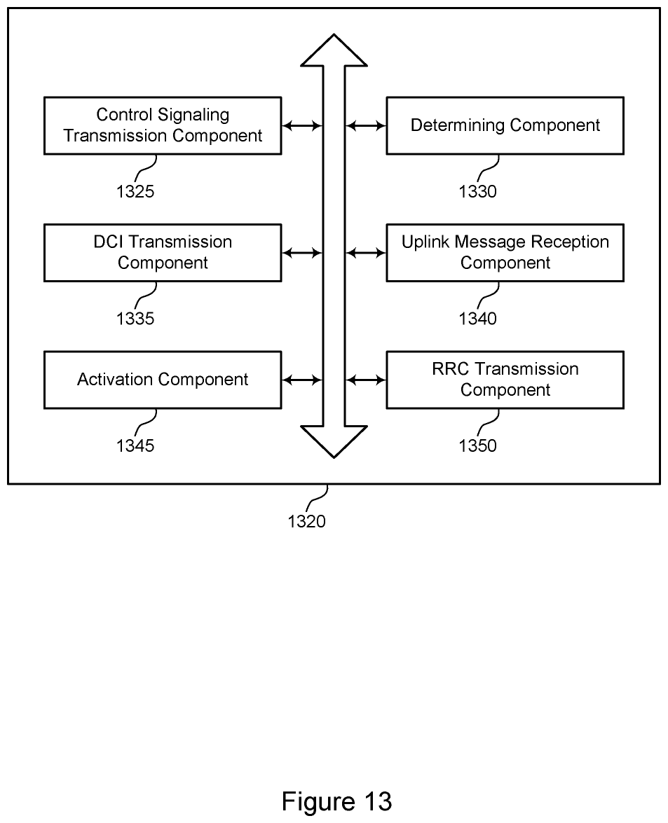

FIG. 13 shows a block diagram of a communications manager 1320 that supports power control parameter configuration for CGs in accordance with aspects of the present disclosure. The communications manager 1320, or various components thereof, may be an example of means for performing various aspects of power control parameter configuration for CGs. For example, the communications manager 1320 may include a control signaling transmission component 1325, a determining component 1330, a DCI transmission component 1335, an uplink message reception component 1340, an activation component 1345, an RRC transmission component 1350, or any combination thereof. Each of these components may communicate, directly or indirectly, with one another (for example, via one or more buses).

The communications manager 1320 may support wireless communications in accordance with examples as disclosed herein. The control signaling transmission component 1325 may be configured as or otherwise support a means for transmitting, to a UE, control signaling configuring a first sounding reference signal resource set, a second sounding reference signal resource set, and a configured grant configuration including a first set of power control parameters and a second set of power control parameters, for configured grant uplink transmission. The DCI transmission component 1335 may be configured as or otherwise support a means for transmitting, to the UE, downlink control information scheduling a retransmission of an uplink message according to the configured grant configuration based on a failure to receive the uplink message from the UE, the downlink control information indicating one or more of the first set of power control parameters or the second set of power control parameters. The uplink message reception component 1340 may be configured as or otherwise support a means for receiving, from the UE, the retransmission of the uplink message using one or both of the first sounding reference signal resource set or the second sounding reference signal resource set based on the indicated one or more of the first set of power control parameters or the second set of power control parameters.

In some examples, the determining component 1330 may be configured as or otherwise support a means for determining a first association between the first set of power control parameters and the first sounding reference signal resource set and a second association between the second set of power control parameters and the second sounding reference signal resource set, in which the receiving the retransmission of the uplink message is further based on the first association, the second association, or both.

In some examples, the activation component 1345 may be configured as or otherwise support a means for activating the configured grant configuration for the UE using the control signaling, in which the retransmission of the uplink message is received based on activating the configured grant configuration for the UE.

In some examples, to support transmitting the control signaling, the RRC transmission component 1350 may be configured as or otherwise support a means for transmitting radio resource control signaling including the first set of power control parameters and the second set of power control parameters. In some examples, to support transmitting the control signaling, the DCI transmission component 1335 may be configured as or otherwise support a means for transmitting first downlink control information activating the configured grant configuration for the UE and indicating one or more sounding reference signal resources of one or both of the first sounding reference signal resource set or the second sounding reference signal resource set, in which the retransmission of the uplink message is received based on the downlink control information activating the configured grant configuration for the UE, and in which the downlink control information scheduling the retransmission of the uplink message includes second downlink control information.

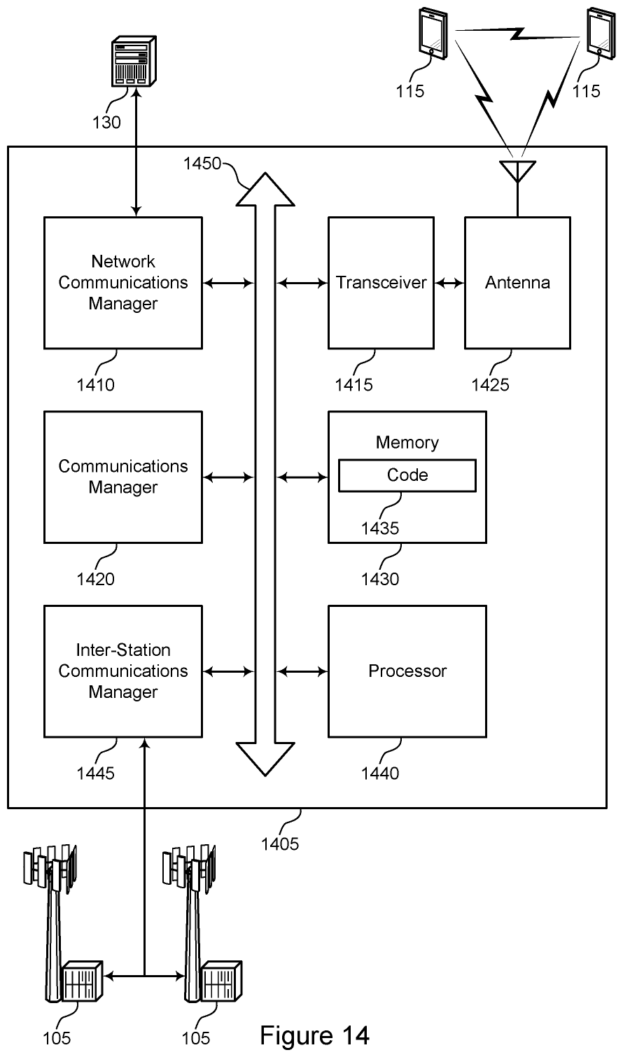

FIG. 14 shows a diagram of a system including a device 1405 that supports power control parameter configuration for CGs in accordance with aspects of the present disclosure. The device 1405 may be an example of or include the components of a device 1105, a device 1205, or a base station 105. The device 1405 may communicate wirelessly with one or more base stations 105, UEs 115, or any combination thereof. The device 1405 may include components for bi-directional voice and data communications including components for transmitting and receiving communications, such as a communications manager 1420, a network communications manager 1410, a transceiver 1415, an antenna 1425, a memory 1430, code 1435, a processor 1440, and an inter-station communications manager 1445. These components may be in electronic communication or otherwise coupled (for example, operatively, communicatively, functionally, electronically, electrically) via one or more buses (for example, a bus 1450).

The network communications manager 1410 may manage communications with a core network 130 (for example, via one or more wired backhaul links). For example, the network communications manager 1410 may manage the transfer of data communications for client devices, such as one or more UEs 115.

In some examples, the device 1405 may include a single antenna 1425. However, in some other examples the device 1405 may have more than one antenna 1425, which may be capable of concurrently transmitting or receiving multiple wireless transmissions. The transceiver 1415 may communicate bi-directionally, via the one or more antennas 1425, wired, or wireless links. For example, the transceiver 1415 may represent a wireless transceiver and may communicate bi-directionally with another wireless transceiver. The transceiver 1415 may also include a modem to modulate the packets, to provide the modulated packets to one or more antennas 1425 for transmission, and to demodulate packets received from the one or more antennas 1425. The transceiver 1415, or the transceiver 1415 and one or more antennas 1425, may be an example of a transmitter 1115, a transmitter 1215, a receiver 1110, a receiver 1210, or any combination thereof or component thereof.

The memory 1430 may include RAM and ROM. The memory 1430 may store computer-readable, computer-executable code 1435 including instructions that, when executed by the processor 1440, cause the device 1405 to perform various functions described herein. The code 1435 may be stored in a non-transitory computer-readable medium such as system memory or another type of memory. In some examples, the code 1435 may not be directly executable by the processor 1440 but may cause a computer (for example, when compiled and executed) to perform functions described herein. In some examples, the memory 1430 may contain, among other things, a BIOS which may control basic hardware or software operation such as the interaction with peripheral components or devices.

The processor 1440 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some examples, the processor 1440 may be configured to operate a memory array using a memory controller. In some other examples, a memory controller may be integrated into the processor 1440. The processor 1440 may be configured to execute computer-readable instructions stored in a memory (for example, the memory 1430) to cause the device 1405 to perform various functions (for example, functions or tasks supporting power control parameter configuration for CGs). For example, the device 1405 or a component of the device 1405 may include a processor 1440 and memory 1430 coupled to the processor 1440, the processor 1440 and memory 1430 configured to perform various functions described herein.

The inter-station communications manager 1445 may manage communications with other base stations 105, and may include a controller or scheduler for controlling communications with UEs 115 in cooperation with other base stations 105. For example, the inter-station communications manager 1445 may coordinate scheduling for transmissions to UEs 115 for various interference mitigation techniques such as beamforming or joint transmission. In some examples, the inter-station communications manager 1445 may provide an X2 interface within an LTE/LTE-A wireless communications network technology to provide communication between base stations 105.

The communications manager 1420 may support wireless communications in accordance with examples as disclosed herein. For example, the communications manager 1420 may be configured as or otherwise support a means for transmitting, to a UE, control signaling configuring a first sounding reference signal resource set, a second sounding reference signal resource set, and a configured grant configuration including a first set of power control parameters and a second set of power control parameters, for configured grant uplink transmission. The communications manager 1420 may be configured as or otherwise support a means for transmitting, to the UE, downlink control information scheduling a retransmission of an uplink message according to the configured grant configuration based on a failure to receive the uplink message from the UE, the downlink control information indicating one or more of the first set of power control parameters or the second set of power control parameters. The communications manager 1420 may be configured as or otherwise support a means for receiving, from the UE, the retransmission of the uplink message using one or both of the first sounding reference signal resource set or the second sounding reference signal resource set based on the indicated one or more of the first set of power control parameters or the second set of power control parameters.

By including or configuring the communications manager 1420, the device 1405 may support techniques for improved communication reliability, reduced latency, reduced power consumption, more efficient utilization of communication resources, improved coordination between devices, and improved utilization of a processing capability.

In some examples, the communications manager 1420 may be configured to perform various operations (for example, receiving, monitoring, transmitting) using or otherwise in cooperation with the transceiver 1415, the one or more antennas 1425, or any combination thereof. Although the communications manager 1420 is illustrated as a separate component, in some examples, one or more functions described with reference to the communications manager 1420 may be supported by or performed by the processor 1440, the memory 1430, the code 1435, or any combination thereof. For example, the code 1435 may include instructions executable by the processor 1440 to cause the device 1405 to perform various aspects of power control parameter configuration for CGs, or the processor 1440 and the memory 1430 may be otherwise configured to perform or support such operations.

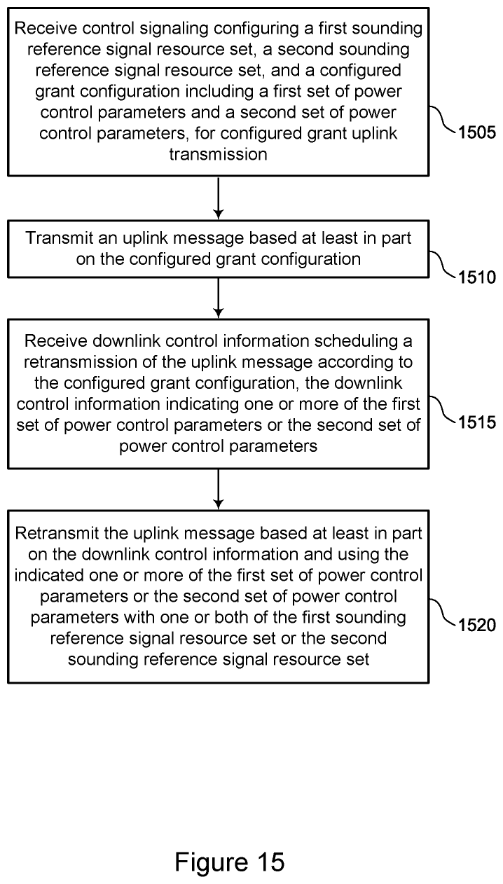

FIG. 15 shows a flowchart illustrating a method that supports power control parameter configuration for CGs in accordance with aspects of the present disclosure. The operations of the method may be implemented by a UE or its components. For example, the operations of the method may be performed by a UE 115 as described with reference to FIGS. 1-10. In some examples, a UE may execute a set of instructions to control the functional elements of the UE to perform the described functions. Additionally or alternatively, the UE may perform aspects of the described functions using special-purpose hardware.

At 1505, the method may include receiving control signaling configuring a first sounding reference signal resource set, a second sounding reference signal resource set, and a configured grant configuration including a first set of power control parameters and a second set of power control parameters, for configured grant uplink transmission. The operations of 1505 may be performed in accordance with examples as disclosed herein. In some examples, aspects of the operations of 1505 may be performed by a control signaling component 925 as described with reference to FIG. 9.

At 1510, the method may include transmitting an uplink message based on the configured grant configuration. The operations of 1510 may be performed in accordance with examples as disclosed herein. In some examples, aspects of the operations of 1510 may be performed by an uplink transmission component 930 as described with reference to FIG. 9.

At 1515, the method may include receiving downlink control information scheduling a retransmission of the uplink message according to the configured grant configuration, the downlink control information indicating one or more of the first set of power control parameters or the second set of power control parameters. The operations of 1515 may be performed in accordance with examples as disclosed herein. In some examples, aspects of the operations of 1515 may be performed by a DCI reception component 935 as described with reference to FIG. 9.

At 1520, the method may include retransmitting the uplink message based on the downlink control information and using the indicated one or more of the first set of power control parameters or the second set of power control parameters with one or both of the first sounding reference signal resource set or the second sounding reference signal resource set. The operations of 1520 may be performed in accordance with examples as disclosed herein. In some examples, aspects of the operations of 1520 may be performed by an uplink transmission component 930 as described with reference to FIG. 9.

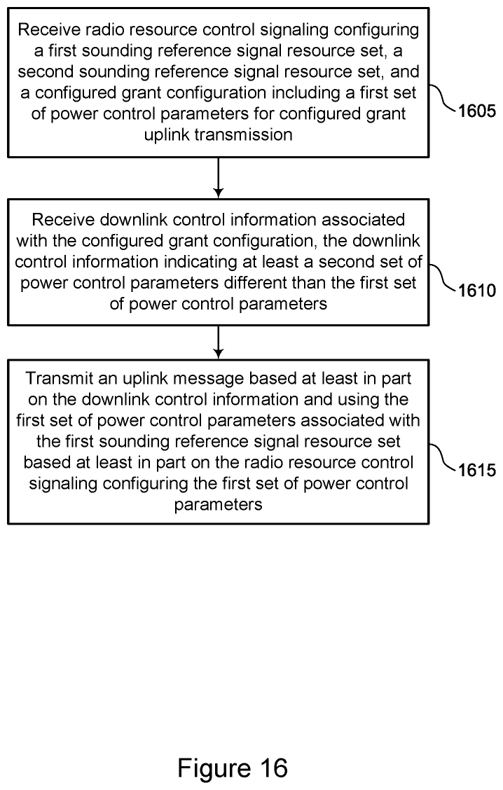

FIG. 16 shows a flowchart illustrating a method that supports power control parameter configuration for CGs in accordance with aspects of the present disclosure. The operations of the method may be implemented by a UE or its components. For example, the operations of the method may be performed by a UE 115 as described with reference to FIGS. 1-10. In some examples, a UE may execute a set of instructions to control the functional elements of the UE to perform the described functions. Additionally or alternatively, the UE may perform aspects of the described functions using special-purpose hardware.

At 1605, the method may include receiving radio resource control signaling configuring a first sounding reference signal resource set, a second sounding reference signal resource set, and a configured grant configuration including a first set of power control parameters for configured grant uplink transmission. The operations of 1605 may be performed in accordance with examples as disclosed herein. In some examples, aspects of the operations of 1605 may be performed by an RRC reception component 940 as described with reference to FIG. 9.

At 1610, the method may include receiving downlink control information associated with the configured grant configuration, the downlink control information indicating at least a second set of power control parameters different than the first set of power control parameters. The operations of 1610 may be performed in accordance with examples as disclosed herein. In some examples, aspects of the operations of 1610 may be performed by a DCI reception component 935 as described with reference to FIG. 9.

At 1615, the method may include transmitting an uplink message based on the downlink control information and using the first set of power control parameters associated with the first sounding reference signal resource set based on the radio resource control signaling configuring the first set of power control parameters. The operations of 1615 may be performed in accordance with examples as disclosed herein. In some examples, aspects of the operations of 1615 may be performed by an uplink transmission component 930 as described with reference to FIG. 9.

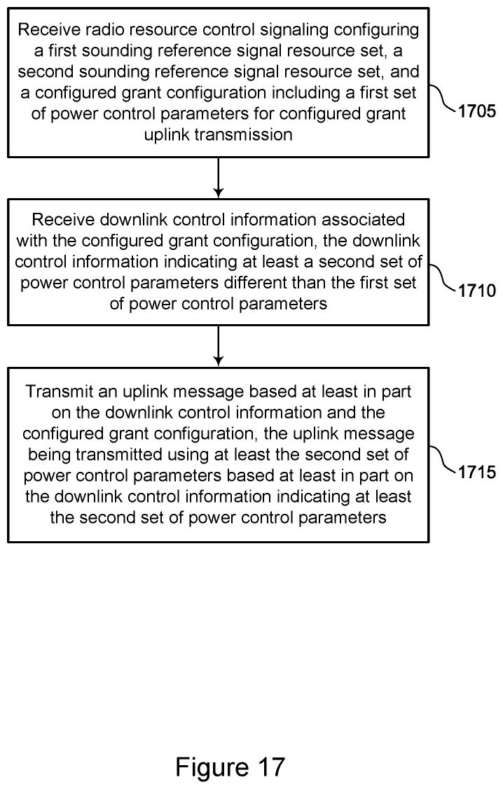

FIG. 17 shows a flowchart illustrating a method that supports power control parameter configuration for CGs in accordance with aspects of the present disclosure. The operations of the method may be implemented by a UE or its components. For example, the operations of the method may be performed by a UE 115 as described with reference to FIGS. 1-10. In some examples, a UE may execute a set of instructions to control the functional elements of the UE to perform the described functions. Additionally or alternatively, the UE may perform aspects of the described functions using special-purpose hardware.

At 1705, the method may include receiving radio resource control signaling configuring a first sounding reference signal resource set, a second sounding reference signal resource set, and a configured grant configuration including a first set of power control parameters for configured grant uplink transmission. The operations of 1705 may be performed in accordance with examples as disclosed herein. In some examples, aspects of the operations of 1705 may be performed by an RRC reception component 940 as described with reference to FIG. 9.

At 1710, the method may include receiving downlink control information associated with the configured grant configuration, the downlink control information indicating at least a second set of power control parameters different than the first set of power control parameters. The operations of 1710 may be performed in accordance with examples as disclosed herein. In some examples, aspects of the operations of 1710 may be performed by a DCI reception component 935 as described with reference to FIG. 9.

At 1715, the method may include transmitting an uplink message based on the downlink control information and the configured grant configuration, the uplink message being transmitted using at least the second set of power control parameters based on the downlink control information indicating at least the second set of power control parameters. The operations of 1715 may be performed in accordance with examples as disclosed herein. In some examples, aspects of the operations of 1715 may be performed by an uplink transmission component 930 as described with reference to FIG. 9.

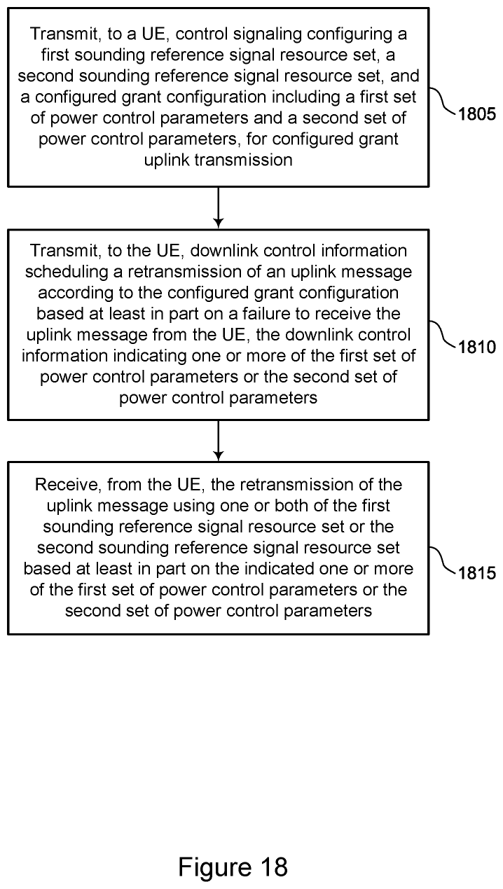

FIG. 18 shows a flowchart illustrating a method that supports power control parameter configuration for CGs in accordance with aspects of the present disclosure. The operations of the method may be implemented by a base station or its components. For example, the operations of the method may be performed by a base station 105 as described with reference to FIGS. 1-6 and 11-14. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, control signaling configuring a first sounding reference signal resource set, a second sounding reference signal resource set, and a configured grant configuration including a first set of power control parameters and a second set of power control parameters, for configured grant uplink transmission. The operations of 1805 may be performed in accordance with examples as disclosed herein. In some examples, aspects of the operations of 1805 may be performed by a control signaling transmission component 1325 as described with reference to FIG. 13.

At 1810, the method may include transmitting, to the UE, downlink control information scheduling a retransmission of an uplink message according to the configured grant configuration based on a failure to receive the uplink message from the UE, the downlink control information indicating one or more of the first set of power control parameters or the second set of power control parameters. The operations of 1810 may be performed in accordance with examples as disclosed herein. In some examples, aspects of the operations of 1810 may be performed by a DCI transmission component 1335 as described with reference to FIG. 13.

At 1815, the method may include receiving, from the UE, the retransmission of the uplink message using one or both of the first sounding reference signal resource set or the second sounding reference signal resource set based on the indicated one or more of the first set of power control parameters or the second set of power control parameters. The operations of 1815 may be performed in accordance with examples as disclosed herein. In some examples, aspects of the operations of 1815 may be performed by an uplink message reception component 1340 as described with reference to FIG. 13.

The following provides an overview of aspects of the present disclosure:

Aspect 1: A method for wireless communications, comprising: receiving control signaling configuring a first sounding reference signal resource set, a second sounding reference signal resource set, and a configured grant configuration comprising a first set of power control parameters and a second set of power control parameters, for configured grant uplink transmission; transmitting an uplink message based at least in part on the configured grant configuration; receiving downlink control information scheduling a retransmission of the uplink message according to the configured grant configuration, the downlink control information indicating one or more of the first set of power control parameters or the second set of power control parameters; and retransmitting the uplink message based at least in part on the downlink control information and using the indicated one or more of the first set of power control parameters or the second set of power control parameters with one or both of the first sounding reference signal resource set or the second sounding reference signal resource set.

Aspect 2: The method of aspect 1, further comprising determining to use one or both of the first sounding reference signal resource set or the second sounding reference signal resource set based at least in part on the downlink control information, a first association between the first set of power control parameters and the first sounding reference signal resource set, and a second association between the second set of power control parameters and the second sounding reference signal resource set, wherein the retransmitting is further based at least in part on the determining.

Aspect 3: The method of any of aspects 1 through 2, wherein the downlink control information comprises a field for dynamic switching, the method further comprising: determining to use: the first set of power control parameters with the first sounding reference signal resource set based at least in part on a first value of the field for dynamic switching, the second set of power control parameters with the second sounding reference signal resource set based at least in part on a second value of the field for dynamic switching, both the first set of power control parameters with the first sounding reference signal resource set and the second set of power control parameters with the second sounding reference signal resource set according to a first order based at least in part on a third value of the field for dynamic switching, or both the first set of power control parameters with the first sounding reference signal resource set and the second set of power control parameters with the second sounding reference signal resource set according to a second order based at least in part on a fourth value of the field for dynamic switching, wherein the retransmitting is further based at least in part on the determining.

Aspect 4: The method of any of aspects 1 through 3, further comprising activating the configured grant configuration based at least in part on receiving the control signaling, wherein the uplink message is transmitted based at least in part on activating the configured grant configuration.

Aspect 5: The method of aspect 4, wherein the configured grant configuration corresponds to a Type 1 configured grant; and the control signaling comprises radio resource control signaling.

Aspect 6: The method of any of aspects 1 through 3, further comprising receiving first downlink control information activating the configured grant configuration, wherein the uplink message is transmitted based at least in part on the first downlink control information activating the configured grant configuration, wherein the control signaling comprises radio resource control signaling and the first downlink control information, and wherein the downlink control information scheduling the retransmission comprises second downlink control information.

Aspect 7: The method of aspect 6, wherein the configured grant configuration corresponds to a Type 2 configured grant; the radio resource control signaling comprises the first set of power control parameters and the second set of power control parameters; and the first downlink control information indicates one or more sounding reference signal resources of one or both of the first sounding reference signal resource set or the second sounding reference signal resource set.

Aspect 8: The method of any of aspects 1 through 7, wherein the downlink control information further comprises a hybrid automatic repeat request process number field indicating a hybrid automatic repeat request process number corresponding to the uplink message transmitted based at least in part on the configured grant configuration and a new data indicator field indicating that the downlink control information schedules the retransmission of the uplink message.

Aspect 9: A method for wireless communications, comprising: receiving radio resource control signaling configuring a first sounding reference signal resource set, a second sounding reference signal resource set, and a configured grant configuration comprising a first set of power control parameters for configured grant uplink transmission; receiving downlink control information associated with the configured grant configuration, the downlink control information indicating at least a second set of power control parameters different than the first set of power control parameters; and transmitting an uplink message based at least in part on the downlink control information and using the first set of power control parameters associated with the first sounding reference signal resource set based at least in part on the radio resource control signaling configuring the first set of power control parameters.

Aspect 10: The method of aspect 9, further comprising transmitting, in response to the downlink control information, a signal comprising an error indication based at least in part on the downlink control information indicating at least the second set of power control parameters and the radio resource control signaling configuring the first set of power control parameters.

Aspect 11: The method of any of aspects 9 through 10, wherein the downlink control information comprises a field for dynamic switching indicating at least the second set of power control parameters, the method further comprising refraining from using the field for dynamic switching based at least in part on the radio resource control signaling failing to configure the second set of power control parameters, wherein transmitting the uplink message using the first set of power control parameters is based at least in part on the refraining.

Aspect 12: The method of any of aspects 9 through 11, wherein the configured grant configuration corresponds to a Type 1 configured grant, the method further comprising activating the configured grant configuration based at least in part on receiving the radio resource control signaling, wherein the uplink message is transmitted based at least in part on activating the configured grant configuration.

Aspect 13: The method of any of aspects 9 through 11, wherein the configured grant configuration corresponds to a Type 1 configured grant or a Type 2 configured grant; the downlink control information schedules a retransmission of the uplink message; and transmitting the uplink message comprises retransmitting the uplink message based at least in part on the downlink control information scheduling the retransmission.

Aspect 14: The method of any of aspects 9 through 11 and 13, further comprising activating the configured grant configuration based at least in part on receiving the downlink control information, wherein the uplink message is transmitted based at least in part on activating the configured grant configuration.

Aspect 15: The method of aspect 14, wherein the configured grant configuration corresponds to a Type 2 configured grant; and the downlink control information further indicates one or more sounding reference signal resources of one or both of the first sounding reference signal resource set or the second sounding reference signal resource set.

Aspect 16: A method for wireless communications, comprising: receiving radio resource control signaling configuring a first sounding reference signal resource set, a second sounding reference signal resource set, and a configured grant configuration comprising a first set of power control parameters for configured grant uplink transmission; receiving downlink control information associated with the configured grant configuration, the downlink control information indicating at least a second set of power control parameters different than the first set of power control parameters; and transmitting an uplink message based at least in part on the downlink control information and the configured grant configuration, the uplink message being transmitted using at least the second set of power control parameters based at least in part on the downlink control information indicating at least the second set of power control parameters.

Aspect 17: The method of aspect 16, wherein the downlink control information comprises a first sounding reference signal resource indicator and a second sounding reference signal resource indicator, and wherein determining the second set of power control parameters comprises determining the second set of power control parameters based at least in part on the second sounding reference signal resource indicator.

Aspect 18: The method of aspect 16, wherein the radio resource control signaling comprises a plurality of sounding reference signal resource indicator power control identifiers associated with the second sounding reference signal resource set, and wherein determining the second set of power control parameters comprises determining the second set of power control parameters based at least in part on a sounding reference signal resource indicator power control identifier of the plurality of sounding reference signal resource indicator power control identifiers associated with the second sounding reference signal resource set and on a selection criterion.

Aspect 19: The method of any of aspects 16 through 18, wherein the downlink control information further indicates the first set of power control parameters, and wherein transmitting the uplink message comprises transmitting a first repetition of the uplink message using the first set of power control parameters based at least in part on the downlink control information and the configured grant configuration; and transmitting a second repetition of the uplink message using the second set of power control parameters based at least in part on the downlink control information and the determining.

Aspect 20: The method of aspect 19, further comprising determining the first set of power control parameters based at least in part on one or more power control parameter fields in the radio resource control signaling.

Aspect 21: The method of aspect 19, wherein the downlink control information comprises a first sounding reference signal resource indicator, the method further comprising determining the first set of power control parameters based at least in part on the first sounding reference signal resource indicator.

Aspect 22: The method of aspect 19, wherein the radio resource control signaling comprises a plurality of sounding reference signal resource indicator power control identifiers associated with the first sounding reference signal resource set, the method further comprising determining the first set of power control parameters based at least in part on a sounding reference signal resource indicator power control identifier of the plurality of sounding reference signal resource indicator power control identifiers associated with the first sounding reference signal resource set and on a selection criterion.

Aspect 23: The method of any of aspects 19 through 22, wherein the downlink control information comprises a field for dynamic switching indicating the first set of power control parameters and the second set of power control parameters, the method further comprising determining an order for transmitting the first repetition and the second repetition based at least in part on a value of the field for dynamic switching, wherein transmitting the first repetition and transmitting the second repetition are based at least in part on the determined order.

Aspect 24: The method of any of aspects 16 through 23, further comprising receiving control signaling indicating to determine the second set of power control parameters if the radio resource control signaling fails to configure the second set of power control parameters and the downlink control information indicates at least the second set of power control parameters, wherein the determining is based at least in part on the control signaling.

Aspect 25: The method of any of aspects 16 through 24, further comprising activating the configured grant configuration based at least in part on receiving the radio resource control signaling, wherein the uplink message is transmitted based at least in part on activating the configured grant configuration.

Aspect 26: The method of any of aspects 16 through 24, further comprising activating the configured grant configuration based at least in part on receiving the downlink control information, wherein the uplink message is transmitted based at least in part on activating the configured grant configuration.

Aspect 27: A method for wireless communications, comprising: transmitting, to a UE, control signaling configuring a first sounding reference signal resource set, a second sounding reference signal resource set, and a configured grant configuration comprising a first set of power control parameters and a second set of power control parameters, for configured grant uplink transmission; transmitting, to the UE, downlink control information scheduling a retransmission of the uplink message according to the configured grant configuration based at least in part on a failure to receive an uplink message from the UE, the downlink control information indicating one or more of the first set of power control parameters or the second set of power control parameters; and receiving, from the UE, the retransmission of the uplink message using one or both of the first sounding reference signal resource set or the second sounding reference signal resource set based at least in part on the indicated one or more of the first set of power control parameters or the second set of power control parameters.

Aspect 28: The method of aspect 27, further comprising determining a first association between the first set of power control parameters and the first sounding reference signal resource set and a second association between the second set of power control parameters and the second sounding reference signal resource set, wherein the receiving the retransmission of the uplink message is further based at least in part on the first association, the second association, or both.

Aspect 29: The method of any of aspects 27 through 28, further comprising activating the configured grant configuration for the UE using the control signaling, wherein the retransmission of the uplink message is received based at least in part on activating the configured grant configuration for the UE.

Aspect 30: The method of any of aspects 27 through 28, wherein transmitting the control signaling comprises: transmitting radio resource control signaling comprising the first set of power control parameters and the second set of power control parameters; and transmitting first downlink control information activating the configured grant configuration for the UE and indicating one or more sounding reference signal resources of one or both of the first sounding reference signal resource set or the second sounding reference signal resource set, wherein the retransmission of the uplink message is received based at least in part on the downlink control information activating the configured grant configuration for the UE, and wherein the downlink control information scheduling the retransmission of the uplink message comprises second downlink control information.

Aspect 31: An apparatus for wireless communications, comprising a processor; memory coupled with the processor; and instructions stored in the memory and executable by the processor to cause the apparatus to perform a method of any of aspects 1 through 8.

Aspect 32: An apparatus for wireless communications, comprising at least one means for performing a method of any of aspects 1 through 8.

Aspect 33: A non-transitory computer-readable medium storing code for wireless communications, the code comprising instructions executable by a processor to perform a method of any of aspects 1 through 8.

Aspect 34: An apparatus for wireless communications, comprising a processor; memory coupled with the processor; and instructions stored in the memory and executable by the processor to cause the apparatus to perform a method of any of aspects 9 through 15.

Aspect 35: An apparatus for wireless communications, comprising at least one means for performing a method of any of aspects 9 through 15.

Aspect 36: A non-transitory computer-readable medium storing code for wireless communications, the code comprising instructions executable by a processor to perform a method of any of aspects 9 through 15.

Aspect 37: An apparatus for wireless communications, comprising a processor; memory coupled with the processor; and instructions stored in the memory and executable by the processor to cause the apparatus to perform a method of any of aspects 16 through 26.

Aspect 38: An apparatus for wireless communications, comprising at least one means for performing a method of any of aspects 16 through 26.

Aspect 39: A non-transitory computer-readable medium storing code for wireless communications, the code comprising instructions executable by a processor to perform a method of any of aspects 16 through 26.

Aspect 40: An apparatus for wireless communications, comprising a processor; memory coupled with the processor; and instructions stored in the memory and executable by the processor to cause the apparatus to perform a method of any of aspects 27 through 30.

Aspect 41: An apparatus for wireless communications, comprising at least one means for performing a method of any of aspects 27 through 30.

Aspect 42: A non-transitory computer-readable medium storing code for wireless communications, the code comprising instructions executable by a processor to perform a method of any of aspects 27 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (that is, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining, or other processes. Also, “determining” can include receiving (such as receiving information), accessing (such as accessing data in a memory), or similar operations. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications, comprising:
receiving control signaling configuring a first sounding reference signal resource set, a second sounding reference signal resource set, and a configured grant configuration comprising a first set of power control parameters and a second set of power control parameters, for configured grant uplink transmission;
transmitting an uplink message based at least in part on the configured grant configuration;
receiving downlink control information scheduling a retransmission of the uplink message according to the configured grant configuration, the downlink control information indicating one or more of the first set of power control parameters or the second set of power control parameters; and
retransmitting the uplink message based at least in part on the downlink control information and using the indicated one or more of the first set of power control parameters or the second set of power control parameters with one or both of the first sounding reference signal resource set or the second sounding reference signal resource set.

2. The method of claim 1, further comprising determining to use one or both of the first sounding reference signal resource set or the second sounding reference signal resource set based at least in part on the downlink control information, a first association between the first set of power control parameters and the first sounding reference signal resource set, and a second association between the second set of power control parameters and the second sounding reference signal resource set, wherein the retransmitting is further based at least in part on the determining.

3. The method of claim 1, wherein the downlink control information comprises a field for dynamic switching, the method further comprising:
determining to use:
the first set of power control parameters with the first sounding reference signal resource set based at least in part on a first value of the field for dynamic switching,
the second set of power control parameters with the second sounding reference signal resource set based at least in part on a second value of the field for dynamic switching,
both the first set of power control parameters with the first sounding reference signal resource set and the second set of power control parameters with the second sounding reference signal resource set according to a first order based at least in part on a third value of the field for dynamic switching, or
both the first set of power control parameters with the first sounding reference signal resource set and the second set of power control parameters with the second sounding reference signal resource set according to a second order based at least in part on a fourth value of the field for dynamic switching,
wherein the retransmitting is further based at least in part on the determining.

4. The method of claim 1, further comprising activating the configured grant configuration based at least in part on receiving the control signaling, wherein the uplink message is transmitted based at least in part on activating the configured grant configuration.

5. The method of claim 4, wherein:
the configured grant configuration corresponds to a Type 1 configured grant; and
the control signaling comprises radio resource control signaling.

6. The method of claim 1, further comprising receiving first downlink control information activating the configured grant configuration, wherein the uplink message is transmitted based at least in part on the first downlink control information activating the configured grant configuration, wherein the control signaling comprises radio resource control signaling and the first downlink control information, and wherein the downlink control information scheduling the retransmission comprises second downlink control information.

7. The method of claim 6, wherein:
the configured grant configuration corresponds to a Type 2 configured grant;
the radio resource control signaling comprises the first set of power control parameters and the second set of power control parameters; and
the first downlink control information indicates one or more sounding reference signal resources of one or both of the first sounding reference signal resource set or the second sounding reference signal resource set.

8. The method of claim 1, wherein the downlink control information further comprises a hybrid automatic repeat request process number field indicating a hybrid automatic repeat request process number corresponding to the uplink message transmitted based at least in part on the configured grant configuration and a new data indicator field indicating that the downlink control information schedules the retransmission of the uplink message.

9. A method for wireless communications, comprising:
receiving radio resource control signaling configuring a first sounding reference signal resource set, a second sounding reference signal resource set, and a configured grant configuration comprising a first set of power control parameters for configured grant uplink transmission;
receiving downlink control information associated with the configured grant configuration, the downlink control information indicating at least a second set of power control parameters different than the first set of power control parameters; and
transmitting an uplink message based at least in part on the downlink control information and using the first set of power control parameters associated with the first sounding reference signal resource set based at least in part on the radio resource control signaling configuring the first set of power control parameters.

10. The method of claim 9, further comprising transmitting, in response to the downlink control information, a signal comprising an error indication based at least in part on the downlink control information indicating at least the second set of power control parameters and the radio resource control signaling configuring the first set of power control parameters.

11. The method of claim 9, wherein the downlink control information comprises a field for dynamic switching indicating at least the second set of power control parameters, the method further comprising refraining from using the field for dynamic switching based at least in part on the radio resource control signaling failing to configure the second set of power control parameters, wherein transmitting the uplink message using the first set of power control parameters is based at least in part on the refraining.

12. The method of claim 9, wherein the configured grant configuration corresponds to a Type 1 configured grant, the method further comprising activating the configured grant configuration based at least in part on receiving the radio resource control signaling, wherein the uplink message is transmitted based at least in part on activating the configured grant configuration.

13. The method of claim 9, wherein:
the configured grant configuration corresponds to a Type 1 configured grant or a Type 2 configured grant;
the downlink control information schedules a retransmission of the uplink message; and
transmitting the uplink message comprises retransmitting the uplink message based at least in part on the downlink control information scheduling the retransmission.

14. The method of claim 9, further comprising activating the configured grant configuration based at least in part on receiving the downlink control information, wherein the uplink message is transmitted based at least in part on activating the configured grant configuration.

15. The method of claim 14, wherein:
the configured grant configuration corresponds to a Type 2 configured grant; and
the downlink control information further indicates one or more sounding reference signal resources of one or both of the first sounding reference signal resource set or the second sounding reference signal resource set.

16. A method for wireless communications, comprising:
receiving radio resource control signaling configuring a first sounding reference signal resource set, a second sounding reference signal resource set, and a configured grant configuration comprising a first set of power control parameters for configured grant uplink transmission;
receiving downlink control information associated with the configured grant configuration, the downlink control information indicating at least a second set of power control parameters different than the first set of power control parameters; and
transmitting an uplink message based at least in part on the downlink control information and the configured grant configuration, the uplink message being transmitted using at least the second set of power control parameters based at least in part on the downlink control information indicating at least the second set of power control parameters.

17. The method of claim 16, wherein the downlink control information comprises a first sounding reference signal resource indicator and a second sounding reference signal resource indicator, and wherein determining the second set of power control parameters comprises determining the second set of power control parameters based at least in part on the second sounding reference signal resource indicator.

18. The method of claim 16, wherein the radio resource control signaling comprises a plurality of sounding reference signal resource indicator power control identifiers associated with the second sounding reference signal resource set, and wherein determining the second set of power control parameters comprises determining the second set of power control parameters based at least in part on a sounding reference signal resource indicator power control identifier of the plurality of sounding reference signal resource indicator power control identifiers associated with the second sounding reference signal resource set and on a selection criterion.

19. The method of claim 16, wherein the downlink control information further indicates the first set of power control parameters, and wherein transmitting the uplink message comprises:
transmitting a first repetition of the uplink message using the first set of power control parameters based at least in part on the downlink control information and the configured grant configuration; and
transmitting a second repetition of the uplink message using the second set of power control parameters based at least in part on the downlink control information and the determining.

20. The method of claim 19, further comprising determining the first set of power control parameters based at least in part on one or more power control parameter fields in the radio resource control signaling.

21. The method of claim 19, wherein the downlink control information comprises a first sounding reference signal resource indicator, the method further comprising determining the first set of power control parameters based at least in part on the first sounding reference signal resource indicator.

22. The method of claim 19, wherein the radio resource control signaling comprises a plurality of sounding reference signal resource indicator power control identifiers associated with the first sounding reference signal resource set, the method further comprising determining the first set of power control parameters based at least in part on a sounding reference signal resource indicator power control identifier of the plurality of sounding reference signal resource indicator power control identifiers associated with the first sounding reference signal resource set and on a selection criterion.

23. The method of claim 19, wherein the downlink control information comprises a field for dynamic switching indicating the first set of power control parameters and the second set of power control parameters, the method further comprising determining an order for transmitting the first repetition and the second repetition based at least in part on a value of the field for dynamic switching, wherein transmitting the first repetition and transmitting the second repetition are based at least in part on the determined order.

24. The method of claim 16, further comprising receiving control signaling indicating to determine the second set of power control parameters if the radio resource control signaling fails to configure the second set of power control parameters and the downlink control information indicates at least the second set of power control parameters, wherein the determining is based at least in part on the control signaling.

25. The method of claim 16, further comprising activating the configured grant configuration based at least in part on receiving the radio resource control signaling, wherein the uplink message is transmitted based at least in part on activating the configured grant configuration.

26. The method of claim 16, further comprising activating the configured grant configuration based at least in part on receiving the downlink control information, wherein the uplink message is transmitted based at least in part on activating the configured grant configuration.

27. A method for wireless communications, comprising:
transmitting, to a user equipment (UE), control signaling configuring a first sounding reference signal resource set, a second sounding reference signal resource set, and a configured grant configuration comprising a first set of power control parameters and a second set of power control parameters, for configured grant uplink transmission;
transmitting, to the UE, downlink control information scheduling a retransmission of an uplink message according to the configured grant configuration based at least in part on a failure to receive the uplink message from the UE, the downlink control information indicating one or more of the first set of power control parameters or the second set of power control parameters; and
receiving, from the UE, the retransmission of the uplink message using one or both of the first sounding reference signal resource set or the second sounding reference signal resource set based at least in part on the indicated one or more of the first set of power control parameters or the second set of power control parameters.

28. The method of claim 27, further comprising determining a first association between the first set of power control parameters and the first sounding reference signal resource set and a second association between the second set of power control parameters and the second sounding reference signal resource set, wherein the receiving the retransmission of the uplink message is further based at least in part on the first association, the second association, or both.

29. The method of claim 27, further comprising activating the configured grant configuration for the UE using the control signaling, wherein the retransmission of the uplink message is received based at least in part on activating the configured grant configuration for the UE.

30. The method of claim 27, wherein transmitting the control signaling comprises:
transmitting radio resource control signaling comprising the first set of power control parameters and the second set of power control parameters; and
transmitting first downlink control information activating the configured grant configuration for the UE and indicating one or more sounding reference signal resources of one or both of the first sounding reference signal resource set or the second sounding reference signal resource set, wherein the retransmission of the uplink message is received based at least in part on the downlink control information activating the configured grant configuration for the UE, and wherein the downlink control information scheduling the retransmission of the uplink message comprises second downlink control information.
